(19) United States
(12) Patent Application Publication
(10) Pub. No.: US 2006/0127040 A1
(43) Pub. Date: Jun. 15, 2006

(54) Information recording medium, information recording device and method, imormation reproduction device and method, information recording/reproduction device and method, computer program for controlling recording or reproduction, and data structure including control signal

(76) Inventors: Nobuyuki Takakuwa, Saitama (JP); Yasuko Fukuda, Saitama (JP); Takao Sawabe, Saitama (JP); Tohru Kanegae, Saitama (JP); Masanori Nakahara, Saitama (JP); Takeshi Koda, Saitama (JP)

Correspondence Address: YOUNG & THOMPSON, 745 SOUTH 23RD STREET, 2ND FLOOR, ARLINGTON, VA, 22202, US

(21) Appl. No.: 10/530,033

(22) PCT Filed: Oct. 1, 2003
(86) PCT No.: PCT/JP03/12577

§ 371 Date: Oct. 14, 2005

(30) Foreign Application Priority Data
Oct. 1, 2002 (JP) 2002288239

(51) Int. Cl. H04N 5/91

(52) U.S. Cl. 386/95

(57) ABSTRACT

Video information indicating a main video, sub-video information indicating a sub-video at least part of which can be displayed superimposedly over the main video, predetermined part coordinate information specifying the coordinates of a predetermined part included in the sub-video in the coordinate system defined with respect to the sub-video, and sub-video control information are recorded on an information recording medium. The sub-video control information includes (i) coordinates-before-movement information specifying the coordinates of a sub-frame before a movement wherein at least a part of the sub-video is the sub-frame and (ii) coordinates-after-movement information specifying the coordinates of the sub-frame after the n-th movement (n is a natural number equal to or greater than 1).

### TECHNICAL FIELD

The present invention relates to: an information record medium, such as a high density optical disc, capable of recording thereon various information such as main picture information or video information, audio information, sub-picture information, reproduction control information, and so on, at high density; an apparatus for and a method of recording the information onto the information record medium; an apparatus for and a method of reproducing the information from the information record medium; an apparatus and a method capable of both recording and reproducing the information; a computer program for controlling the recording or reproduction; and a data structure including a control signal.

### BACKGROUND ART

DVDs become common as optical discs onto which various information such as main picture information, audio information, sub-picture information, reproduction control information and so on is recorded. According to a DVD standard, the main picture information (video data), the audio information (audio data) and the sub-picture information (sub-picture data) are packetized each with the reproduction control information (navigation data) and are multi-recorded onto a disc in a program stream format of MPEG 2 (Moving Picture Experts Group phase 2), which is a high performance encoding technology. Among them, the main picture information has data, which is compressed in a MPEG video format (ISO 13818-2), for one stream in one program stream. On the other hand, the audio information is recorded in a plurality of formats (i.e. linear PCM, AC-3, MPEG audio and so on) and has data for up to 8 streams in one program stream. The sub-picture information is defined by a bitmap, and is compressed and recorded in a run length method, and has data for up to 32 streams in one program stream.

On the other hand, a transport stream format of MPEG2 standard is coming to be standardized, which is suitable for data transfer. According to the transport stream format, a plurality of elementary streams are transferred at the same time. For example, a plurality of programs, such as a plurality of satellite digital broadcasting channels in one satellite radio wave, are transmitted at the same time in a TDM (Time Division Multiplex) scheme.

According to DVDs of this type, sub-picture information may be recorded as sub-video information such as a caption or subtitle of a movie, in association with the video information as the main video information. Furthermore, for example, it is possible to display various button images such as a menu selection button or an operation execution button on the main picture, with the aid of the sub-picture information. In this case, it is also possible to highlight the button image with different brightness, with different colors or the like, depending on the operation status, so that the button operation status is indicated, for example whether or not the button is selected, clicked or depressed with the aid of a remote controller or the like. That is, in DVD players, on the basis of the sub-picture information and the high light information, it is possible to display a menu screen including a plurality of buttons or selectable item frames.

On the other hand, in DVD players, it is also possible to scroll up-and-down character lines displayed by means of the sub-picture information, in a display area of the sub-picture occupying a predetermined area on the displayed main picture.

### DISCLOSURE OF INVENTION

However, according to the high light display control of the button using the sub-picture on the basis of the aforementioned DVD video standard, a position allowing the high light control by means of the high light information is fixed relative to the display screen or the main picture. That is, the high light is defined relative to the button image. For this, only simple display controls can be achieved, such as a high light display with the improved brightness of the operation button. In other words, according to the conventional DVD, there is employed a control scheme in which a highlightened image based on the high light information is overlapped on the button image as a back ground image based on the button information. For this, there is a problem that an area in which the button is highlightened is deviated from the button image, if the button image is moved by the scrolling of the sub-picture within the display area of the sub-picture displayed in a predetermined area on the main picture.

In this manner, according to the conventional DVD, there is a problem that it is technically difficult to perform a complicated and sophisticated display control using the sub-picture, for example, scrolling the sub-picture including the highlightened button.

The present invention has been accomplished in view of the above problems for example. It is therefore an object of the present invention to provide an information record medium, an information record apparatus and method, an information reproduction apparatus and method, an information record reproduction apparatus and method, a computer program for a record or reproduction control, and a data structure including a control signal for a reproduction control, which enable the complicated and sophisticated display control using the sub-video information, such as a control of scrolling the sub-picture appropriately including the highlightened button.

The information record medium according to the present invention includes: video information to indicate a main video; sub-video information to indicate a sub-video, the sub-video at least partially displayable over the main video; predetermined part coordinate information to designate coordinates of a predetermined part included in the sub-video, in a coordinate system defined with respect to the sub-video; and sub-video control information including (i) coordinates-before-movement information to indicate coordinates of a sub-frame before a movement in the coordinate system, the sub-frame being at least an area of the sub-video, and (ii) coordinates-after-movement information to indicate coordinates of the sub frame after n-th movement (n is natural number equal to or more than 1) in the coordinate system.

According to the information record medium of the invention, at the reproduction of the information record medium such as a DVD, it is possible to display, as a sub-frame, at least a part of the sub-video information, which may be made the sub-video information, as it is or after subjected to some treatment or processing, superimposed on the main video such as the main video or the video display image. Such sub-video information may be image data such as bit map data or JPEG data. Incidentally, the sub-video information may be superimposed and displayed as a whole over the main video. Alternatively, a part of the sub-video information may be cut out as a sub-frame and displayed. Alternatively, one or more sub-frames may be cut out from the same sub-video information. In the case that a plurality of sub-frames are cut out, they may be cut out in such a manner that individual pieces have any common part, or may be cut out in such a manner that individual pieces have no common part.

Then, for the reproduction of the information record medium, the coordinates of the predetermined part, which is included in the sub-video and may be the button video part including a plan view, a design, an icon, a picture and so on to indicate a button or may be an item frame having a special shape, is designated by the predetermined part coordinate information in the coordinate system defined for the sub-video. For example, if the predetermined part has a rectangular shape, such coordinates may be coordinates of opposing two or four corners. Furthermore, if the predetermined part has any arbitrary shape, the coordinates may be coordinates sufficient to identify the arbitrary shape.

Such predetermined part coordinate information may be streamed into a SPD (Sub-Picture Data) stream with the sub-video information and recorded. However, it may be streamed into a SCP (Sub-Picture Control Packet) stream with the sub-video control information and recorded, or may be recorded in other schemes, or recorded into other record areas.

Under the condition of such a data structure, a discussion is made on the case of scrolling the displayed contents of the sub-frame in the display area of the sub-frame displayed in the predetermined area on the main video. Incidentally, the display area of the sub-frame on the main video is fixed relative to the main video, if it is a simple area. That is, in the coordinate system defined for the main video, the coordinates or a range of an outline of the sub-frame is fixed. It is possible, however, to move a display position of the outline of the sub-frame itself, or change a size of the outline of the sub-frame. In any case, it is possible to change the displayed contents within the sub-frame displayed on the main video by moving the sub-frame, which is cut out from the sub-video, relative to the sub-video. Then, typically due to the movement of the sub-frame from side to side or up and down relative to the sub-video, a scroll display is achieve in the sub-frame to be finally displayed on the main video.

Before the movement of the sub-frame (i.e. before the scrolling), firstly, the coordinates of the sub-frame on the sub-video are determined with the aid of the coordinates-before-movement information, so that the sub-frame is cut out and displayed over the main video. In this case, a display position of the predetermine part such as the button video part is identified relative to the main video in a relationship with the sub-frame, on the basis of the predetermined part coordinate information and the coordinates-before-movement information. Incidentally, if there are a plurality of predetermined parts, display positions of individual predetermined parts are also identified relative to the main video, on the basis of a plurality of predetermined part coordinate information. It is possible to identify display positions of such individual predetermined parts, even if the sub-frame (or the outline thereof) is displayed in any area of the main video.

Then, after the movement of the sub-frame (i.e. after the scroll is begun), the coordinates of the sub-frame on the sub-video is identified with the aid of the coordinates-after-movement information, so that the sub-frame is cut out and displayed over the main video. In this case, the display position of the predetermined part which may be the button video part is identified relative to the main video in the relationship with the sub-frame, on the basis of the predetermined part coordinate information and the coordinates-after-movement information. Incidentally, if there are a plurality of predetermined parts, display positions of individual predetermined parts are also identified relative to the main video, on the basis of a plurality of predetermined part coordinate information. It is possible to identify display positions of such individual predetermined parts, even if the sub-frame (the outline thereof) is displayed in any area of the main video.

Therefore, in the case that a predetermined processing such as highlighting is performed relative to the predetermined part, such as the button video part, defined in the coordinate system of the sub-video, it is possible to perform the predetermined processing relative to the predetermined part even before or after the movement of the sub-frame. That is, by moving the sub-frame on the sub-video including the button video part to be highlighted, the position to be highlighted cannot be deviated from the position of the button video part defined in the coordinate system of the sub-video, even if the position of the button video part is moved within the sub-frame. Furthermore, if the sub-frame is moved continuously in accordance with a frame rate of the main video, the smooth scroll display can be achieved due to the continuous movement of the sub-frame.

Consequently, it is possible to achieve the complex and sophisticated display control using the sub-video, such as scrolling the sub-video including highlightened button.

In an aspect of the information record medium of the invention, the predetermined part is a button video part, and the predetermined part coordinate information is button position information to indicate coordinates of the button video part.

According to this aspect, in the case that the predetermined processing such as highlighting is performed relative to the button video part defined in the coordinate system of the sub-video, it is possible to perform the predetermined processing relative to the button video part even before or after the movement of the sub-frame. Therefore, it is possible to scroll appropriately the sub-frame including, for example, the highlighted button video part.

The “button position information” herein is coordinate information or area information to define the button video part, for example, as a rectangular area. Furthermore, the “button” herein may be a push button (i.e. a simple pressable button), a toggle button (i.e. a button to switch statuses every time when the button is operated), an exclusive button (i.e. a plurality of buttons allowing only one thereamong being pressed down) and the like. These buttons are operated with the aid of a remote controller, an audio input, a touch operation on a screen, a key board operation and the like. Additionally, an area of the button video part capable of acting as a button may be an entire area of the button video part, or may be an opaque part of the button video part indicated by alpha value to indicate transparency for example.

In an aspect relating to the button video part, the sub-video control information may further include first button status information to indicate an operational status of a button, which is indicated by the button video part before the movement of the sub-frame.

In such an arrangement, at the reproduction of the information record medium, it is possible to firstly display the button video part within the sub-frame, in an appropriate operating status such as a status in which each button is selectable by default or a status in which each button is not selectable by default, on the basis of the first button status information included in the reproduced sub-video control information before the movement of the sub-frame (i.e. before a scrolling). Incidentally, the “predetermined kinds of button status” includes a status allowing an operation of a button while the button is selected, not selected or executed, or a status not allowing any operation of a button.

In an aspect relating to the button video part, the sub-video control information may further include second button status information to indicate in which status a button, which is indicated by the button video part after the n-th movement of the sub-frame, is among the predetermined kinds of preset button status.

In such an arrangement, at the reproduction of the information record medium, it is possible to display the button video part within the sub-frame in an appropriate operating status such as a status in which each button is selectable after the scrolling or a status in which each button is not selectable after the scrolling, on the basis of the second button status information included in the reproduced sub-video control information after the movement of the sub-frame (i.e. after the scrolling).

In an aspect relating to the button video part, the sub-video control information further includes button command information to define a button command to be executed in a case that the button is operated.

In such an arrangement, at the reproduction of the information record medium, it is possible to issue the button command further defined by the button information in the information reproduction apparatus presently reproducing the media, in the case that the predetermined button operation is performed relative to the button defined by the button information. Therefore, in the information reproduction apparatus, the button command can be executed quickly.

In an aspect relating to the button video part, the record medium may further include: high light information to define how to control a high light display for the button video part.

In such an arrangement, how to control the high light display is defined relative to the button video part, on the basis of the reproduced high light information. The “how to control the high light display” herein means which high light display is to be performed depending on the “button status”, such as pressed, selected, impressed, unselected, pressable or selectable, impressable or unselectable and so on. The high light display control may be performed specifically by displaying a button to be highlightened in such a manner that the button is distinguished from other buttons or other parts, by changing the brightness, changing the contrast, giving a reverse shading, depending on the button status.

Therefore, by performing the display control based on the button position information and the high light information, the button video made of at least a part of the sub-video can be displayed over the main video, and functioned as an operating button to operate the information reproduction apparatus or the reproduction operation.

This high light information may be included in the sub-video control information such as the belowmentioned SCP (Sub-Picture Control Packet) with the coordinates-before-movement information and the coordinates-after-movement information, or may be included in the sub-video information set such as the belowmentioned SPD (Sub-Picture Data) with the sub-video information and the predetermined coordinate information. In the former case, the belowmentioned SCP button can be displayed for example. In the latter case, the belowmentioned SPD button can be displayed.

In an aspect of this button video part, the high light information to define how to control the high light display may define which display mode is used to perform the high light display among predetermined kinds of preset display mode, depending on the button status among predetermined kinds of preset button status of a button displayed on the main video.

In such an arrangement, if the predetermined button operation is performed at the reproduction of the information record medium, it is possible to highlight the corresponding button in a display mode defined by the high light information in the information reproduction apparatus. Incidentally, the “predetermined kinds of display mode” includes various modes such as a brightness change of the button, a contrast change of the button, a hue (color phase) change of the button, a color saturation change of the button, a change to the complementary color, an existence or nonexistence of the reverse shading, a vibration display and so on, in addition to a simple local brightening.

In another aspect of the information record medium of the invention, a sub-video information set comprises the sub-video information and the predetermined part coordinate information, and the main video information, the sub-video information set and the sub-video control information are divided into predetermined packets and multiplexed, and further streamed into a video stream comprising the divided main video, a sub-video stream comprising the divided sub-video information set and a control information stream comprising the divided sub-video control information.

According to this aspect, similarly to the PS of the MPEG2 for example, in the case that each information is packetized, streamed and recorded, the sub-video information set such as the SPD made of the sub-video information and the predetermined part coordinate information is recorded as a special SPD stream, while the sub-video control information for the display control of the sub-video information is recorded as a special SCP stream, that is another stream different from the SPD. Furthermore, the main video is also recorded as a special video stream for example. therefore, a display based on the sub-video information set recorded as one stream in the PS for example can be controlled for the display efficiently by the sub-video control information recorded as another stream. Additionally, by using a plurality of sub-video control information streams relative to the same sub-video information set stream, various buttons can be highlightened. For example, by using the same sub-video information set, they can be functioned as different operating buttons.

The information record apparatus according to the present invention includes: a first record device for recording video information to indicate a main video; a second record device for recording sub-video information to indicate a sub-video, the sub-video at least partially displayable over the main video, and predetermined part coordinate information to designate coordinates of a predetermined part included in the sub-video, in a coordinate system defined with respect to the sub-video; and a third record device for recording sub-video control information including (i) coordinates-before-movement information to indicate coordinates of a sub-frame before a movement in the coordinate system, the sub-frame being at least an area of the sub-video, and (ii) coordinates-after-movement information to indicate coordinates of the sub frame after n-th movement (n is natural number equal to or more than 1) in the coordinate system.

According to the information record medium of the invention, the first record device such as a controller, an encoder, a TS object generator mentioned below, an optical pickup, a cutting device or the like, records the video information to indicate the main video onto the information record medium such as a DVD. The second record device such as a controller, an encoder, an optical pickup, a cutting device or the like, records the predetermined part coordinate information to designate the coordinates of the predetermined part such as the button video part onto the information record medium such as a DVD. The third record device such as a controller, an encoder, an optical pickup, a cutting device or the like, records the sub-video control information including the coordinates-before-movement information and the coordinates-after-movement information relating to the sub-frame.

Therefore, the information record medium of the invention mentioned above (including various aspects thereof) can be recorded relatively efficiently.

Incidentally, the information record apparatus according to the present invention may also take various aspects, correspondingly to various aspects of the information record medium according to the present invention as mentioned above.

The information record method according to the present invention includes: a first record process of recording video information to indicate a main video; a second record process of recording sub-video information to indicate a sub-video, the sub-video at least partially displayable over the main video, and predetermined part coordinate information to designate coordinates of a predetermined part included in the sub-video, in a coordinate system defined with respect to the sub-video; and a third record process of recording sub-video control information including (i) coordinates-before-movement information to indicate coordinates of a sub-frame before a movement in the coordinate system, the sub-frame being at least an area of the sub-video, and (ii) coordinates-after-movement information to indicate coordinates of the sub frame after n-th movement (n is natural number equal to or more than 1) in the coordinate system.

According to the information record method of the invention, the first record process is for recording the video information to indicate the main video, the second record process is for recording the predetermined part coordinate information included in the sub-video and the sub-video information, and the third record process is for recording the sub-video control information including the coordinates-before-movement information and the coordinates-after-movement information relating to the sub-frame, onto the information record medium such as a DVD, with the aid of a controller, an encoder, a TS object generator mentioned below, an optical pickup, a cutting device or the like.

Therefore, the information record medium according to the present invention as mentioned above (including various aspects thereof) can be recorded relatively efficiently.

Incidentally, the information record method according to the present invention may also take various aspects, correspondingly to various aspects of the information record medium according to the present invention.

The information reproduction apparatus according to the present invention is for reproducing the information record medium according to the present invention mentioned above (including various aspects thereof), and comprises: a reproduction device for reproducing the video information, the sub-video information, the predetermined part coordinate information and the sub-video control information; a display output device capable of displaying the reproduced sub-video information over the reproduced video information; and a control device for controlling the reproduction device and the display output device to display, before the movement of the sub-frame, the predetermined part within the sub-frame before the movement after the predetermined part is subjected to a predetermined kind of processing on the basis of the reproduced predetermined part coordinate information, while displaying the sub-frame before the movement over the main video on the basis of the coordinates-before-movement information included in the reproduced sub video control information, and to display, after the movement of the sub-frame, the predetermined part within the sub-frame after the movement after the predetermined part is subjected to a predetermined kind of processing on the basis of the reproduced predetermined part coordinate information, while displaying the sub-frame after the movement over the main video on the basis of the coordinates-after-movement information included in the reproduced sub-video control information.

According to the information reproduction apparatus of the invention, the reproduction device such as a controller, a decoder, a demultiplexer, an optical pickup and the like reproduces the video information, the sub-video information, the predetermined part coordinate information and the sub-video control information. For example, the display output device such as a CRT (Cathode Ray Tube) device, a PDP (Plasma Display Panel) device, an LCD (Liquid Crystal Display) device, a projector device and so on is capable of displaying and outputting the sub-video information over the reproduced video information. Before the movement of the sub-frame (e.g. before a scroll), the control device such as a controller or the like controls the reproduction device and the display output device so that the sub-frame-before-movement is displayed over the main video, on the basis of the coordinates-before-movement information, while the predetermined part such as the button video part is displayed within the sub-frame-before-movement after subjected to the predetermined processing such as highlighting, on the basis of the predetermined part coordinate information. Then, after the movement of the sub-frame, the control device controls the reproduction device and the display output device so that the sub-frame-after-movement is displayed over the main video, on the basis of the coordinates-after-movement information, while the predetermined part such as the button video part is displayed within the sub-frame-after-movement after subjected to the predetermined processing such as highlighting.

Therefore, the information record medium according to the present invention as mentioned above (including various aspects thereof) can be reproduced relatively efficiently.

Incidentally, the first information reproduction apparatus according to the present invention may also take various aspects, correspondingly to various aspects of the information record medium according to the present invention.

In an aspect of the information reproduction apparatus of the invention, the predetermined part is a button video part, the predetermined part coordinate information is button position information to indicate coordinates of the button video part, the information record medium further comprises high light information to define how to control a high light display for the button video part, the reproduction device further reproduces the high light information, and the control device controls the reproduction device and the display output device to perform the high light display as the predetermined kind of processing for the button video part, on the basis of the reproduced high light information.

According to this aspect, for example, it is possible to scroll the sub-frame including highlightened button video part within the predetermined area on the main video.

The information reproduction method according to the present invention is a method of reproducing the information record medium according to the present invention mentioned above (including various aspects thereof), and implemented with an information reproduction apparatus comprising (i) a reproduction device for reproducing the video information, the sub-video information, the predetermined part coordinate information and the sub-video control information and (ii) a display output device capable of displaying the reproduced sub-video information over the reproduced video information, the method comprising: a first control process of controlling the reproduction device and the display output device to display, before the movement of the sub-frame, the predetermined part within the sub-frame before the movement after the predetermined part is subjected to a predetermined kind of processing on the basis of the reproduced predetermined part coordinate information, while displaying the sub-frame before the movement over the main video on the basis of the coordinates-before-movement information included in the reproduced sub video control information; and a second control process of controlling the reproduction device and the display output device to display, after the movement of the sub-frame, the predetermined part within the sub-frame after the movement after the predetermined part is subjected to a predetermined kind of processing on the basis of the reproduced predetermined part coordinate information, while displaying the sub-frame after the movement over the main video on the basis of the coordinates-after-movement information included in the reproduced sub-video control information.

According to the information reproduction method of the invention, the first control process is for controlling, before the movement of the sub-frame (e.g. before a scroll), the reproduction device and the display output device so that the sub-frame-before-movement is displayed over the main video, on the basis of the coordinates-before-movement information, while the predetermined part such as the button video part is displayed within the sub-frame-before-movement after subjected to the predetermined processing such as highlighting, on the basis of the predetermined part coordinate information, with the aid of the controller, the decoder, the demultiplexer, the optical pickup and so on. Then, a second control process is for controlling, after the movement of the sub-frame, the reproduction device and the display output device so that the sub-frame-after-movement is displayed over the main video, on the basis of the coordinates-after-movement information, while the predetermined part such as the button video part is displayed within the sub-frame-after-movement after subjected to the predetermined processing such as highlighting.

Therefore, the information record medium of the invention mentioned above (including various aspects thereof) can be recorded relatively efficiently.

Incidentally, the information reproduction method according to the present invention may also take various aspects, correspondingly to various aspects of the information record medium according to the present invention as mentioned above.

The information record reproduction apparatus according to the present invention includes: a first record device for recording video information to indicate a main video; a second record device for recording sub-video information to indicate a sub-video, the sub-video at least partially displayable over the main video, and predetermined part coordinate information to designate coordinates of a predetermined part included in the sub-video, in a coordinate system defined with respect to the sub-video; a third record device for recording sub-video control information including (i) coordinates-before-movement information to indicate coordinates of a sub-frame before a movement in the coordinate system, the sub-frame being at least an area of the sub-video, and (ii) coordinates-after-movement information to indicate coordinates of the sub frame after n-th movement (n is natural number equal to or more than 1) in the coordinate system; a reproduction device for reproducing the video information, the sub-video information, the predetermined part coordinate information and the sub-video control information; a display output device capable of displaying the reproduced sub-video information over the reproduced video information; and a control device for controlling the reproduction device and the display output device to display, before the movement of the sub-frame, the predetermined part within the sub-frame before the movement after the predetermined part is subjected to a predetermined kind of processing on the basis of the reproduced predetermined part coordinate information, while displaying the sub-frame before the movement over the main video on the basis of the coordinates-before-movement information included in the reproduced sub video control information, and to display, after the movement of the sub-frame, the predetermined part within the sub-frame after the movement after the predetermined part is subjected to a predetermined kind of processing on the basis of the reproduced predetermined part coordinate information, while displaying the sub-frame after the movement over the main video on the basis of the coordinates-after-movement information included in the reproduced sub-video control information.

According to the information record reproduction apparatus of the invention, since there are provided both functions of the information record apparatus and the information reproduction apparatus according to the present invention, the information record medium of the invention mentioned above (including various aspects thereof) can be recorded relatively efficiently.

Incidentally, the information record reproduction apparatus according to the present invention may also take various aspects, correspondingly to various aspects of the information record medium according to the present invention as mentioned above.

The information record reproduction method according to the present invention is a method implemented with an information reproduction apparatus comprising (i) a reproduction device for reproducing the video information, the sub-video information, the predetermined part coordinate information and the sub-video control information and (ii) a display output device capable of displaying the reproduced sub-video information over the reproduced video information, said method comprising: a first record process of recording video information to indicate a main video; a second record process of recording sub-video information to indicate a sub-video, the sub-video at least partially displayable over the main video, and predetermined part coordinate information to designate coordinates of a predetermined part included in the sub-video, in a coordinate system defined with respect to the sub-video; a third record process of recording sub-video control information including (i) coordinates-before-movement information to indicate coordinates of a sub-frame before a movement in the coordinate system, the sub-frame being at least an area of the sub-video, and (ii) coordinates-after-movement information to indicate coordinates of the sub frame after n-th movement (n is natural number equal to or more than 1) in the coordinate system; a first control process of controlling the reproduction device and the display output device to display, before the movement of the sub-frame, the predetermined part within the sub-frame before the movement after the predetermined part is subjected to a predetermined kind of processing on the basis of the reproduced predetermined part coordinate information, while displaying the sub-frame before the movement over the main video on the basis of the coordinates-before-movement information included in the reproduced sub video control information; and a second control process of controlling the reproduction device and the display output device to display, after the movement of the sub-frame, the predetermined part within the sub-frame after the movement after the predetermined part is subjected to a predetermined kind of processing on the basis of the reproduced predetermined part coordinate information, while displaying the sub-frame after the movement over the main video on the basis of the coordinates-after-movement information included in the reproduced sub-video control information.

According to the information record reproduction method of the invention, since it has both function of the information record method and the information reproduction method of the invention mentioned above, the information record medium of the invention (including various aspects thereof) can be recorded and reproduced relatively efficiently.

Incidentally, the information record reproduction method according to the present invention may also take various aspects, correspondingly to various aspects of the information record medium according to the present invention.

The computer program according to the present invention is a computer program for a record control to control a computer disposed at the information record apparatus according to the present invention mentioned above (including various aspects thereof), the program making the computer function as at least a part of the first record device, the second record device and the third record device.

According to the computer program for a record control of the invention, the information record apparatus according to the present invention mentioned above may be embodied relatively easily, by reading and running the computer program from a record medium, such as a ROM, a CD-ROM, a DVD-ROM, a hard disk and so on, storing the computer program therein/thereon, or by downloading the computer program to the computer via the communication device and running it.

Incidentally, the computer program for a record control according to the present invention may also take various aspects, correspondingly to various aspects of the information record medium according to the present invention as mentioned above.

The computer program for a reproduction control according to the present invention is to control a computer disposed at the information reproduction apparatuses according to the present invention mentioned above (including various aspects thereof), the program making the computer function as at least a part of the reproduction device, the display output device and the control device.

According to the computer program for a reproduction control of the invention, the information reproduction apparatus according to the present invention mentioned above may be embodied relatively easily, by reading and running the computer program from a record medium, such as a ROM, a CD-ROM, a DVD-ROM, a hard disk and so on, storing the computer program therein/thereon, or by downloading the computer program to the computer via the communication device and running it.

Incidentally, the computer program for the reproduction control according to the present invention may also take various aspects, correspondingly to various aspects of the information record medium according to the present invention as mentioned above.

The computer program for a record reproduction control according to the present invention is to control a computer disposed at the information record reproduction apparatus according to the present invention mentioned above (including various aspects thereof), the program making the computer function as at least a part of the first record device, the second record device, the third record device, the reproduction device, the display output device and the control device.

According to the computer program for a record reproduction control of the invention, the information record reproduction apparatus according to the present invention mentioned above may be embodied relatively easily, by reading and running the computer program from a record medium, such as a ROM, a CD-ROM, a DVD-ROM, a hard disk and so on, storing the computer program therein/thereon, or by downloading the computer program to the computer via the communication device and running it.

Incidentally, the computer program for the record reproduction control according to the present invention may also take various aspects, correspondingly to various aspects of the information record medium according to the present invention as mentioned above.

The data structure including a control signal according to the present invention includes: video information to indicate a main video; sub-video information to indicate a sub-video, the sub-video at least partially displayable over the main video; predetermined part coordinate information to designate coordinates of a predetermined part included in the sub-video, in a coordinate system defined with respect to the sub-video; and sub-video control information including (i) coordinates-before-movement information to indicate coordinates of a sub-frame before a movement in the coordinate system, the sub-frame being at least an area of the sub-video, and (ii) coordinates-after-movement information to indicate coordinates of the sub frame after n-th movement (n is natural number equal to or more than 1) in the coordinate system.

According to the data structure including the control signal of the invention, similarly to the information record medium according to the present invention mentioned above, it is possible to achieve the complex and sophisticated display control using the sub-video, such as a control by scrolling the sub-picture including the highlightened button.

Incidentally, the data structure including the control signal according to the present invention may also take various aspects, correspondingly to various aspects of the information record medium according to the present invention as mentioned above.

The above object of the present invention is achieved by a computer program product for a record control in a computer-readable medium for tangibly embodying a program of instructions executable by a computer disposed at the aforementioned information record apparatus according to the present invention (including various aspects), the program making the computer function as at least a part of the first record device, the second record device and the third record device.

The above object of the present invention is achieved by a computer program product for a reproduction control in a computer-readable medium for tangibly embodying a program of instructions executable by a computer disposed at the information reproduction apparatus according to the present invention (including various aspects), the program making the computer function as at least a part of the reproduction device, the display output device and the control device.

The above object of the present invention is achieved by a computer program product for a record reproduction control in a computer-readable medium for tangibly embodying a program of instructions executable by a computer disposed at the information record reproduction apparatus according to the present invention (including various aspects), the program making the computer function as at least a part of the first record device, the second record device, the third record device, the reproduction device, the display output device and the control device.

According to the computer program product for the record control, the reproduction control, or the record reproduction control of the invention, at least a part of the first record device, the second record device, the reproduction device, the display output device and the control device according to the present invention mentioned above may be embodied relatively easily, by reading and running the computer program product from a record medium, such as a ROM, a CD-ROM, a DVD-ROM, a hard disk and so on, storing the computer program therein/thereon, or by downloading the computer program product to the computer via the communication device and running it. More specifically, the computer program product may be made of computer readable codes (or computer readable commands) to make the computer function as at least a part of the first record device, the second record device, the third record device, the reproduction device and the control device.

These effects and other advantages of the present invention become more apparent from the following embodiments and examples.

### BRIEF DESCRIPTION OF DRAWINGS

FIG. 1 illustrates, in its upper part, a general plan view of an optical disc as an embodiment of the information record medium of the present invention; and illustrates, in its lower part, a schematic conceptual diagram of an area structure in a radius direction corresponding to the general plan view in the upper part.

FIG. 2 illustrates a schematic conceptual diagram (FIG. 2(a)) of a conventional program stream of MPEG2; a schematic conceptual diagram (FIG. 2(b)) of a transport stream of MPEG2 used in the embodiment; and a schematic conceptual diagram (FIG. 2(c)) of a program stream of MPEG2 used in the embodiment.

FIG. 3 is a diagram schematically illustrating a data structure recorded on the optical disc in the embodiment.

FIG. 4 is a conceptual diagram hierarchically illustrating a detail of a data structure in each title shown in FIG. 3.

FIG. 5 is a conceptual diagram hierarchically illustrating a detail of a data structure in each play list set shown in FIG. 3

FIG. 6 is a conceptual diagram schematically illustrating a detail of a data structure in each play list set shown in FIG. 3.

FIG. 7 is a conceptual diagram schematically illustrating a detail of a data structure of each item shown in FIG. 6.

FIG. 8 is a conceptual diagram schematically illustrating a logic structure of data in each title element shown in FIG. 4.

FIG. 9 is a conceptual view schematically illustrating a logic structure of data in each title element shown in FIG. 4, in a case that each play list set is composed of one play list.

FIG. 10 is a conceptual view schematically illustrating a detail of a data structure in each object shown in FIG. 3.

FIG. 11 is a view schematically illustrating a situation that an elementary stream for a program #1, shown in the upper column, and an elementary stream for a program #2, shown in the middle column, are multiplexed to form a transport stream for these two programs, on the basis of a time scale in a horizontal direction.

FIG. 12 is a conceptual view conceptually illustrating an image of TS packets multiplexed in one transport stream in the embodiment, as a packet arrangement based on the time scale.

FIG. 13 is a view schematically illustrating a logic structure of data on an optical disc in the embodiment, focusing on development from a logic hierarchy to an object hierarchy or an entity hierarchy.

FIG. 14 is a block diagram schematically illustrating an information record reproduction apparatus in the embodiment.

FIG. 15 is a flow chart indicating a recording operation (part 1) of the information record reproduction apparatus in the embodiment.

FIG. 16 is a flow chart indicating a recording operation (part 2) of the information record reproduction apparatus in the embodiment.

FIG. 17 is a flow chart indicating a recording operation (part 3) of the information record reproduction apparatus in the embodiment.

FIG. 18 is a flow chart indicating a recording operation (part 4) of the information record reproduction apparatus in the embodiment.

FIG. 19 is a flow chart indicating a reproduction operation of the information record reproduction apparatus in the embodiment.

FIG. 20 is a conceptual diagram illustrating a specific example of the sub-picture structure including the SP control information and the SP data in the embodiment.

FIG. 21 is a conceptual diagram illustrating another specific example of the sub-picture structure including the SP control information and the SP data in the embodiment.

FIGS. 22 are schematic diagrams showing three types of sub-picture structures, constructed from the sub-picture structures shown in FIG. 20 and FIG. 21.

FIG. 23 is a schematic diagram showing a relationship among a SPD stream and a plurality of SCP streams, with respect to a reproduction time axis.

FIG. 24 is a conceptual view showing a cut out position of the sub-frame and the button mark position relative to the SP data, and a highlighted button, for the scroll control of the highlighted button, in the embodiment.

FIG. 25 is another conceptual view showing a cut out position of the sub-frame and the button mark position relative to the SP data, and a highlighted button, for the scroll control of the highlighted button, in the embodiment.

FIG. 26 is a conceptual diagram illustrating a specific contents example of the SP control data and the SP data in the sub-picture structure shown in FIG. 20.

FIG. 27 is a flow chart showing an operational flow of scrolling the highlighted button in the embodiment.

FIG. 28 is another flow chart showing an operational flow of scrolling the highlighted button in the embodiment.

FIG. 29 is a view conceptually illustrating a general flow of an access during a reproduction in the embodiment, showing in association with a logic structure of an optical disc.

FIG. 30 is a diagram schematically showing a specific example of a data structure in an AU table constructed in the object information file and an ES map table associated with the AU table, in a specific example of the embodiment.

### BEST MODE FOR CARRYING OUT THE INVENTION

(Information Record Medium)

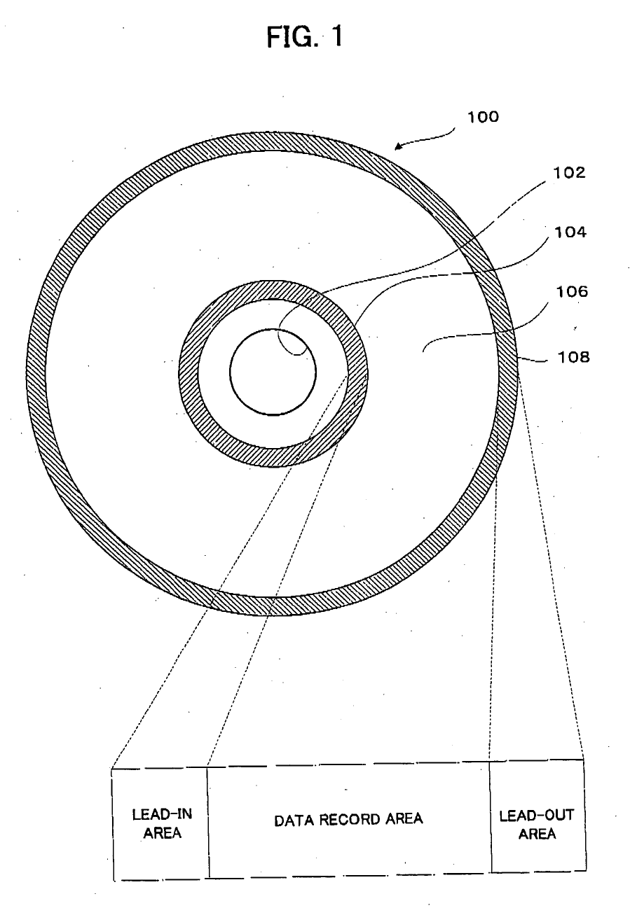

The information record medium of the present invention is discussed, with reference to its embodiments, as well as FIG. 1 to FIG. 13. In these embodiments, the information record medium of the present invention is applied to an optical disc capable of recording (writing) and reproducing (reading).

Firstly, with reference to FIG. 1, a fundamental structure of the optical disc in an embodiment is discussed. FIG. 1 illustrates, in its upper part, a general plan view of the optical disc structure having a plurality of areas, and illustrates conceptually, in its lower part, an area structure in the radius direction corresponding to the upper part.

As shown in FIG. 1, the optical disc 100 may be recorded by various record methods, such as a magneto-optical method, a phase change method, capable of recording (writing) only once or a plurality of times. Similarly to DVDs, the optical disc 100 has a lead-in area 104, a data area 106 and a lead-out area 108, from the inner circumference around a center hole 102 to the outer circumference, on the record surface of the disc body measuring about 12 cm in diameter. In each area, groove tracks and land tracks may be alternately arranged, concentrically or spirally around the center hole 102. The groove tracks may be wobbled. Furthermore, pre-pits may be formed on one or both of these tracks. Incidentally, the present invention is not exclusively limited to the optical disc having three areas mentioned above.

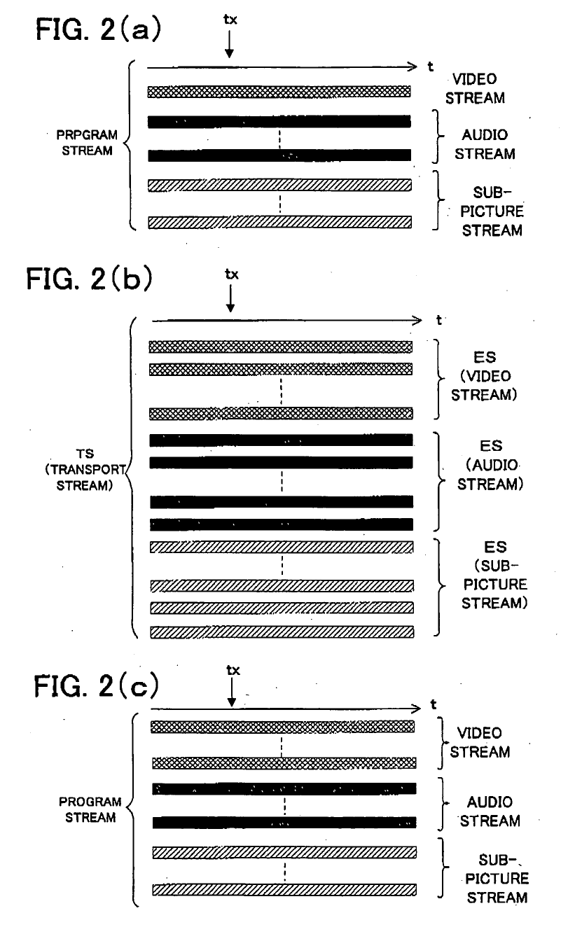

Next, with reference to FIG. 2, the structures of the transport stream (TS) and the program stream (PS) to be recorded onto the optical disc in the embodiment are discussed. FIG. 2(a) schematically illustrates a MPEG2 program stream of a conventional DVD for a comparison, FIG. 2(b) schematically illustrates a MPEG2 transport stream (TS) structure. Furthermore, FIG. 2(c) schematically illustrates a MPEG2 program stream structure in the present invention.

In FIG. 2(a), one program stream to be recorded in the conventional DVD includes only one video stream for video data as main picture information, along the time axis t, and further includes up to 8 audio streams of audio data as audio information, up to 32 sub-picture streams for sub-picture data as sub-picture information. That is, the video data to be multiplexed at an arbitrary time point tx relates to only one video stream. For example, a plurality of video stream corresponding to a plurality of TV programs or a plurality of movies can not be included at the same time in the program stream. It is not possible to multiplex a plurality of TV programs and transfer or record them, in a program stream format of a DVD having only one video stream, because at least one video stream is required for each TV program, in order to transfer or record the multiplexed TV program or the like involving a video image.

In FIG. 2(b), one transport stream (TS) to be recorded in the optical disc 100 of the present invention includes a plurality of video streams as elementary streams (ES) for video data as main picture information, and further includes a plurality of audio streams as elementary streams (ES) for audio data as audio information and a plurality of sub-picture streams as elementary streams (ES) for sub-picture as sub-picture information. That is, the video data to be multiplexed at an arbitrary time point tx relates to a plurality of video streams. For example, a plurality of video streams that may correspond to a plurality of TV programs or a plurality of movies can be included at the same time in the transport stream. Thus, it is possible to multiplex a plurality of TV programs and transfer or record them, in the transport stream format having a plurality of video streams. However, the sub-picture stream is not transferred in a digital broadcasting employing the existing transport stream.

In FIG. 2(c), one program stream (PS) to be recorded onto the optical disc 100 of the present invention includes a plurality of video streams for video data as main picture information, and further includes a plurality of audio streams for audio data as audio information and a plurality of sub-picture streams for sub-picture data as sub-picture information. That is, the video data to be multiplexed at an arbitrary time point tx relates to a plurality of video streams. For example, a plurality of video streams that may correspond to a plurality of TV programs or a plurality of movies can be included at the same time in the program stream.

Incidentally, for convenience of explanation, the video stream, the audio stream and the sub-picture stream are arranged in this order from the top in FIG. 2(a) to FIG. 2(c). Nevertheless, this order or sequence does not correspond to an order or sequence for multiplexing packet by packet as mentioned below. In the transport stream, conceptually, a set of one video stream, two audio streams and two sub-picture streams corresponds to one program for example.

The optical disc 100 in the aforementioned embodiment is adapted to multi-record the transport stream (TS) as shown in FIG. 2(b), i.e. to record a plurality of programs at the same time. Furthermore, instead of or in addition to this transport stream, the program stream (PS) as shown in FIG. 2(c) can be multi-recorded onto the same optical disc 100.

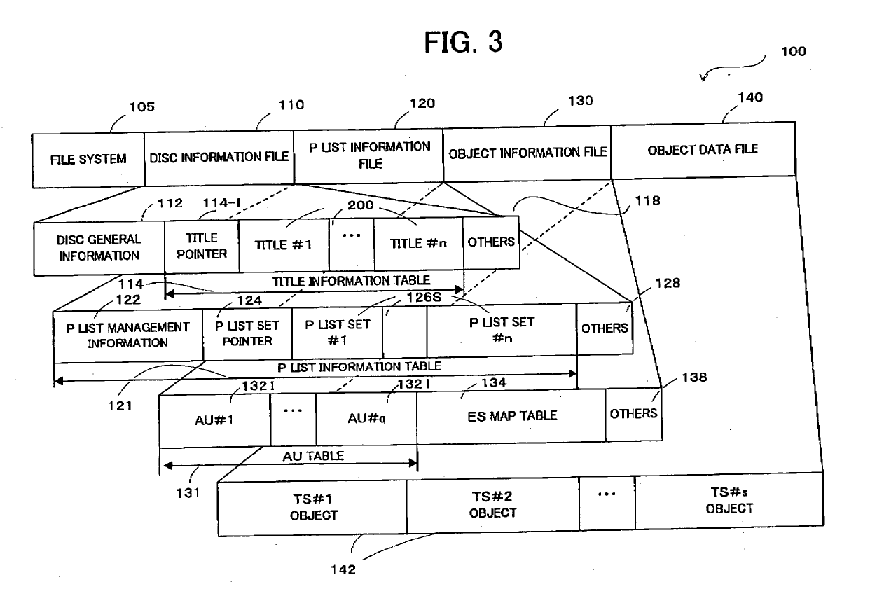

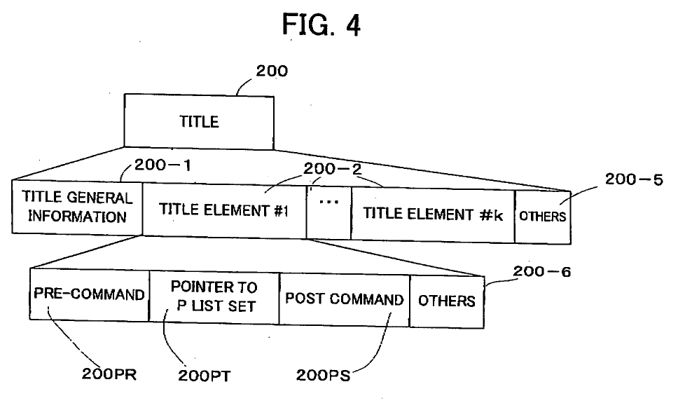

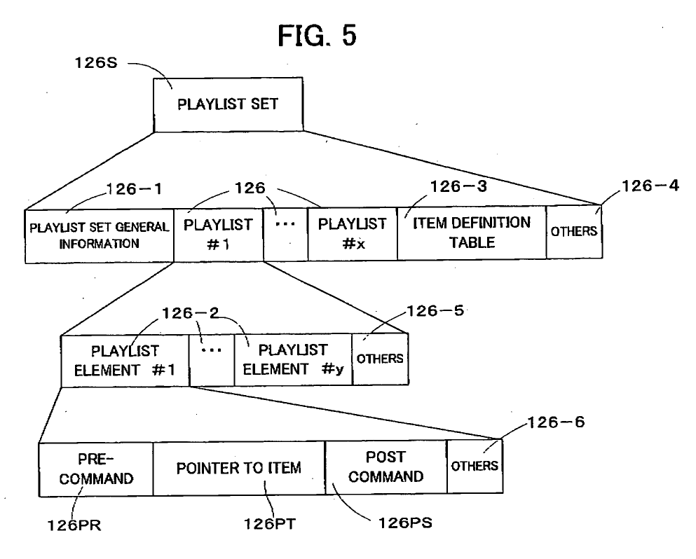

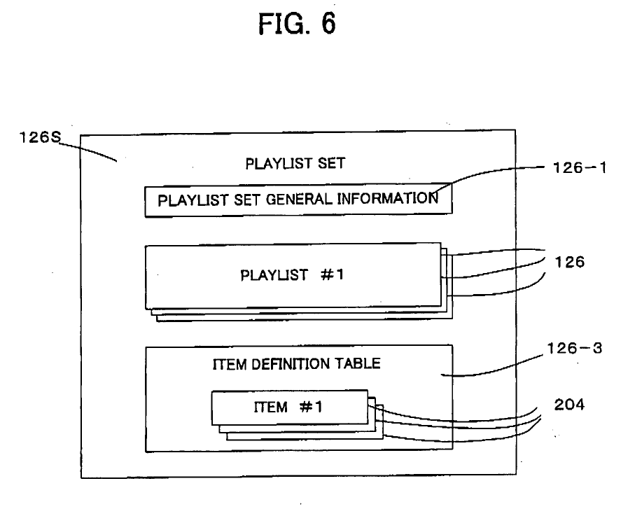

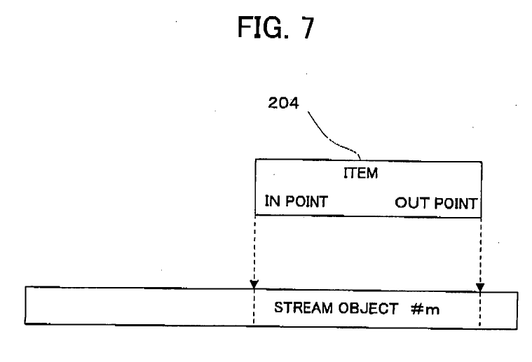

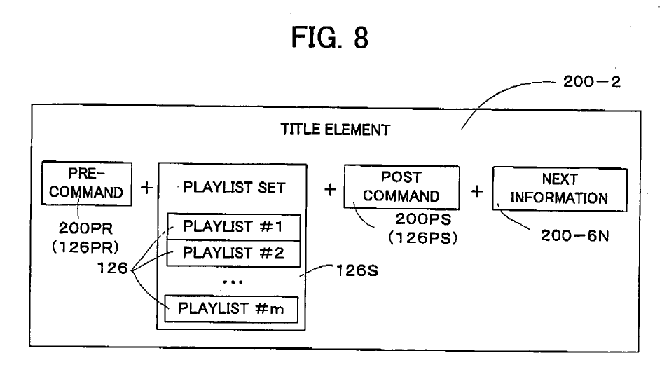

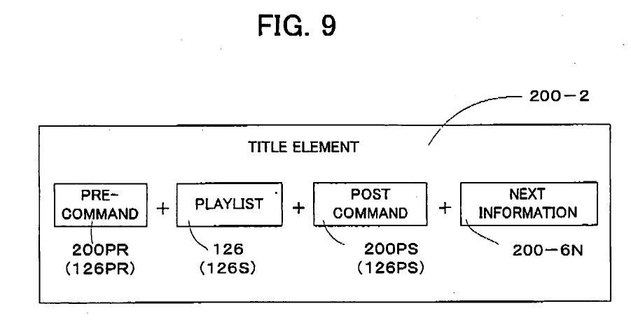

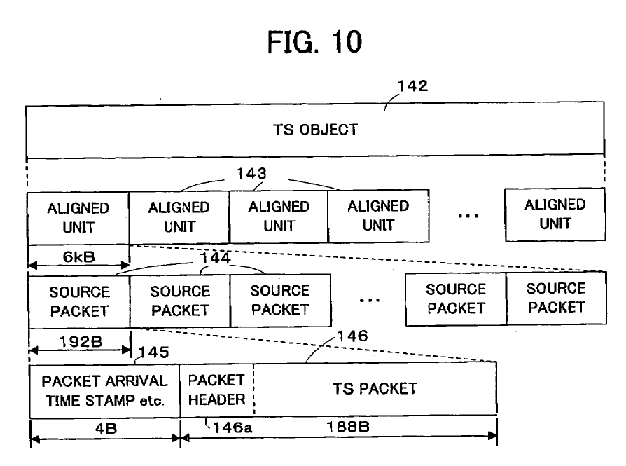

Next, with reference to FIG. 3 and FIG. 10, a structure of data to be recorded onto the optical disc 100 is discussed. FIG. 3 schematically illustrates the data structure to be recorded onto the optical disc 100. FIG. 4 schematically illustrates in detail the data structure in each object shown in FIG. 3. FIG. 5 and FIG. 6 schematically show a data structure in detail respectively in each play list (P list) set shown in FIG. 3. FIG. 7 schematically shows a detail of the data structure of each item shown in FIG. 6. FIG. 8 schematically shows a logic structure of data in each title element shown in FIG. 4. FIG. 9 schematically shows a logic structure of data in each title element, in a case that each play list set is composed of one play list. FIG. 10 schematically shows a detail of a data structure in each object shown in FIG. 3.

In the following explanation, the “title” means a reproduction unit, on the basis of which a plurality of “play lists” are executed continuously or sequentially, and which is a logically large grouped unit, such as one movie or one TV program. The “play list set” means a bundle of “play lists”. For example, it may be a bundle of play lists to reproduce a plurality of content information having a special relationship switchable to each other in an angle reproduction or a parental reproduction, or may be a bundle of play lists to reproduce content information relating to a plurality of programs broadcasted in the same time zone and collectively recorded. Alternatively, it may be a bundle of play lists to reproduce various content information, in one title, prepared on the basis of required function, for example on the basis of video performance or audio performance required for the information reproduction system, such as a high vision compatibility, a display resolution, a surround speaker compatibility, a speaker layout and so on. The “play list” is information for storing the information required to reproduce the “object” and consists of a plurality of “items” each storing the information about a reproduction range of the object to access the object. The “object” is the entity information of contents constructing the aforementioned MPEG2 transport stream.

In FIG. 3, the optical disc 100 is provided with four files as a logical structure: a disc information file 110; a play list (P list) information file 120; an object information file 130; and an object data file 140. The disc 100 is further provided with a file system 105 for managing these files. Incidentally, although FIG. 3 does not show directly the physical data arrangement on the optical disc 100, it is possible to perform the recording in such a manner that the arrangement shown in FIG. 3 corresponds to another arrangement shown in FIG. 1. That is, it is possible to record the file system 105 or the like in the data record area 106 following the lead-in area 104 and further record the object data file 140 or the like in the data record area 106. The file structure shown in FIG. 3 can be constructed, even without the lead-in area 104 or the lead-out area 108 shown in FIG. 1.

The disc information file 110 is a file for storing general information about the entire optical disc 100, and stores the disc general information 112, the title information table 114 and other information 118. The disc general information 112 may store the total numbers of titles or the like in the optical disc 100. The title information table 114 includes a title pointer 114-1 and a plurality of titles 200 (title #1-#m) whose ID (identification) number or record address is indicated by the title pointer. In each title 200, each title type (e.g. sequential reproduction type, branch type and so on), or the play list (P list) number constructing each title is recorded for each title, as the logical information.

More specifically, for example, as shown in FIG. 4, each title 200 is made of a title general information 200-1, a plurality of title elements 200-2 and other information 200-5. Furthermore, each title element 200-2 is made of a pre-command 200PR, a pointer 200PT to a play list set, a post command 200PS and other information 200-6.

The pointer 200PT as an example of the first pointer information according to the present invention indicates an ID number of the play list set 126S stored in the play list information file 120 corresponding to content information to be reproduced on the basis of the title element 200-2 including the pointer 200PT. Incidentally, the pointer 200PT may be information to indicate a record position of the play list set 126S corresponding to the content information to be reproduced on the basis of the title element 200-2. The pre-command 200PR as an example of the first pre-command according to the present invention indicates a command to be executed before reproducing the content information whose reproduction sequence is defined by one play list set 126S designated by the pointer 200PT. The post command 200PS as an example of the first post command according to the present invention is a command to be executed after reproducing the content information whose reproduction sequence is defined by said one play list set. Other information 200-5 included in the title element 200-2 may include next information to designate a title element for a next reproduction after the present reproduction of the present title element, for example.

Therefore, when the information reproduction apparatus reproduces the information record medium, the desired content information can be reproduced as a title element 200-2, by making access to the play list set 126S in accordance with the pointer 200PT and performing a control to select play list corresponding to the desired program or the like from among a plurality of play lists 126 in the play list set 126S. Furthermore, reproducing such a title element 200-2 solely or sequentially makes it possible to reproduce one title 200. Furthermore, it is possible to execute commands to be executed before reproduction, in the content information whose reproduction sequence is defined by one play list set 126S designated by the pointer 200PT, according to the pre-command 200PR. Furthermore, it is possible to execute commands to be executed after the reproduction, in the content information whose reproduction sequence is defined by one play list set 126S designated by the pointer 200PT, according to the post command 200PS. The post command 200PS may be a command to branch the content information, a command to select a next title and so on. Additionally, it is possible to reproduce a next title element 200-2 to be reproduced after the presently reproduced title element 200-2, according to the “next information” included in other information 200-5.

Again in FIG. 3, the play list information file 120 stores the play list (P list) information table 121 indicating the logical structure of each play list. This table 121 is divided into the play list (P list) management information 122, the play list (P list) set pointer 124, a plurality of play list (P list) sets 126S (P list set #1-#n), and other information 128. In this play list information table 121, the logical information of each play list set 126S is stored in the order of the play list set number. In other words, the order for storing the each play list set 126S is the play list set numbers. Furthermore, in the aforementioned title information table 114, the same play list set 126S can be referred from a plurality of titles 200. That is, the play list set #p in the play list information table 121 may be pointed on the title information table 114, even in the case that title #q and title #r use the same play list set #p.

As shown in FIG. 5, the play list set 126S includes play list set general information 126-1, a plurality of play lists 126 (play list #1-#x), an item definition table 126-3, and other information 126-4. Each play list 126 includes a plurality of play list elements 126-2 (play list element #1-#y), and other information 126-5. Furthermore, each play list element 126-2 includes a pre-command 126PR, a pointer 126PT to item, a post command 126PS and other information 126-6.

The pointer 126PT as an example of the second pointer information according to the present invention indicates an item identification number defined by the item definition table 126-3 corresponding to the content information to be reproduced on the basis of the play list element 126-2 including the pointer 126PT. Incidentally, the pointer 126PT may be an item record position defined by the item definition table 126-3.

As shown in FIG. 6, in the play list set 126S, a plurality of items 204 are defined in the item definition table 126-3. They are commonly belonged to a plurality of play lists 126. Furthermore, as the play list set general information 126-1, a name of each play list 126 included in the play list set 126S, UI (user interface information) such as a reproduction time, address information to each item definition table 126-3 and so on are recorded.

Again in FIG. 5, the pre-command 126PR as an example of the second pre-command according to the present invention indicates a command to be executed before reproduction of one item 204 designated by the pointer 126PT. The post command 126PS as an example of the second post command according to the present invention indicates a command to be executed after the reproduction of said one item 204. Other information 126-6 included in the play list element 126-2 may include the next information to designate the play list element 126-2 relating to the next reproduction of the reproduction of the play list element 126-2.

As shown in FIG. 7, the item 204 is a minimum unit to be displayed. In the item 204, “in-point information” to indicate a start address of an object and “out-point information” to indicate an end address of the object are recorded. Incidentally, each of these “in-point information” and “out-point information” may indicate the address directly or indirectly as a time period or time point on the reproduction time scale. In the figure, if a plurality of ESs (Elementary Streams) are multiplexed for the object designated by “stream object #m”, designating the item 204 means designating a special ES or special combination of ESs.

As shown in FIG. 8, the title element 200-2 logically consists of the pre-command 200PR or 126PR, the play list set 126S selected by the pointer 200PT, the post command 200PT or 126PS, and the next information 200-6N. Therefore, a processing to select the play list 126 from among the play list set 126S is executed, according to any condition reproducible in a system, such as video resolution.

As shown in FIG. 9, however, if the play list set designated by the pointer 200PT consists of only one play list, i.e. if the play list set 126S shown in FIG. 3 is replaced by a single play list 126, the title element 200-2 logically consists of the pre-command 200PR or 126PR, the play list 126 to be reproduced during the reproduction operation, the post command 200PS or 126PS, and the next information 200-6N. In this case, once the play list set is designated for the reproduction, the single play list 126 is reproduced, regardless of the condition reproducible in the system.

Again in FIG. 3, in the object information file 130, the storage position (i.e. the logical address of the reproduction object) in the object data file 140 for each item constructed in each play list 126, and/or various attribute information relating to the reproduction of the item are stored. Particularly in this embodiment, the object information file 130 stores the AU table 131 including a plurality of AU (Associate Unit) information 132I (AU #1-#q) as mentioned below, the ES (Elementary Stream) map table 134 and other information 135.

The object data file 140 stores a plurality of TS objects 142 for each transport stream (TS #1 object-TS #s object), i.e. entity data of contents to be actually reproduced.

Incidentally, four kinds of file discussed with reference to FIG. 3 can be further divided into a plurality of files respectively to be stored. All these files may be managed by the file system 105. For example, the object data file 140 can be divided into a plurality of files such as object data file #1, object data file #2 and so on.

As shown in FIG. 10, the TS object 142 shown in FIG. 3, as a logically reproducible unit, may be divided into a plurality of aligned units 143 each having 6 kB of data amount. The head of the aligned units 143 is aligned with the head of the TS object 142. Each aligned unit 143 is further divided into a plurality of source packets 144 each having 192B of data amount. The source packet 144 is a physically reproducible unit, on the basis of which (i.e. packet by packet) at least the video data, the audio data and the sub-picture data from among the data on the optical disc 100 are multiplexed, and other information may be multiplexed in the same manner. Each source packet 144 includes the control information 145 having 4B of data amount to control the reproduction, such as the packet arrival time stamp or the like indicating the reproduction start time point of the TS (Transport Stream) packet on the reproduction time scale, and includes the TS packet 146 having 188B of data amount. The TS packet 146 (also referred to as “TS packet payload”) has a packet header 146a at its head portion. The video data may be packetized as the “video packet”, the audio data may be packetized as the “audio packet”, or the sub-picture data may be packetized as the “sub-picture packet”, otherwise other data may be packetized.

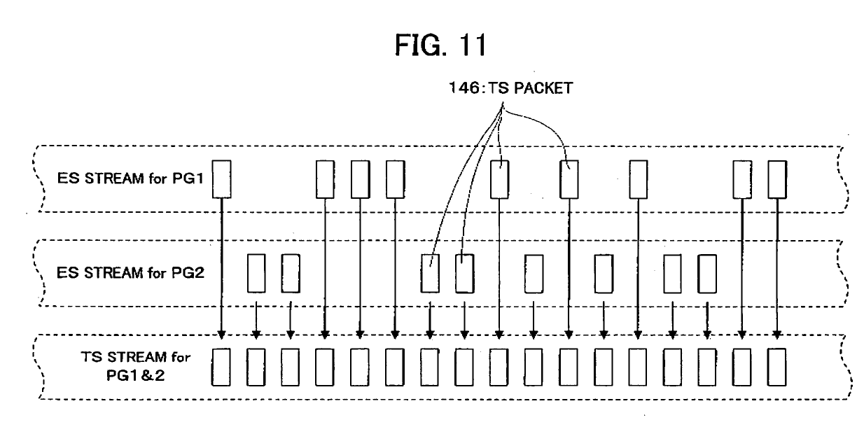

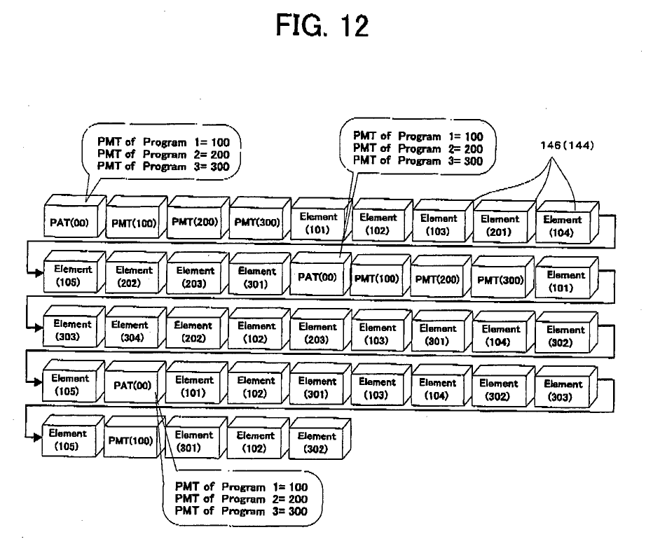

Next, with reference to FIG. 11 and FIG. 12, an explanation is made on the multi-recording of the video data, the audio data, the sub-picture data and the like in the transport stream format as shown in FIG. 2(b), by the TS packet 146 shown in FIG. 4. FIG. 11 conceptually illustrates that the elementary stream (ES) for program #1 (PG1) in the upper stage and the elementary stream (ES) for program #2 (PG2) in the middle stage are multiplexed, and the transport stream (TS) for these two programs (PG1&2) is formed, under an assumption that a horizontal axis is defined as a time axis. FIG. 12 conceptually illustrates an image of the TS packets multiplexed in one transport stream (TS), as a packet array along the time (sic).

As shown in FIG. 11, the elementary stream for program #1 (in the upper stage) may be formed by discretely arranging TS packets 146 obtained by packetizing the video data for program #1, along the time axis. The elementary stream for program #2 (in the middle stage) may be formed by discretely arranging TS packets obtained by packetizing the video data for program #2, along the time axis. Then, these TS packets 146 are multiplexed so that the transport stream (in the lower stage) for two programs is made. Incidentally, omitted for convenience of explanation in FIG. 11, the elementary stream made of TS packets obtained by packetizing the audio data as the elementary stream for program #1, and/or the sub-picture stream made of TS packets obtained by packetizing the sub-picture data may be multiplexed similarly, as shown in FIG. 2(b). In addition to this, the elementary stream made of TS packets obtained by packetizing the audio data, as the elementary stream for program #2, and the sub-picture stream made of TS packets obtained by packetizing the sub-picture data may be multiplexed similarly.

As shown in FIG. 12, in this embodiment, a plurality of TS packets 146 multiplexed as such forms one TS stream. Then, a plurality of TS packets 146 in the multiplexed form is multi-recorded onto the optical disc 100, with the information such as the packet arrival time stamp 145 and the like being added. Incidentally, in FIG. 12, the TS packet 146 consisting of the data forming program #i (i=1, 2, 3) is indicated by “element (i0j)”, wherein, j (j=1, 2, . . .) is a sequential number for each stream composing the program. This (i0j) is defined as a packet ID which is an identification number of the TS packet 146 for each elementary stream. This packet ID is fixed at an inherent value for a plurality of TS packets 146 to be multiplexed at the same time point, so that the plurality of TS packets 146 are distinguished from each other even if multiplexed at the same time point.

Furthermore, in FIG. 12, the PAT (Program Association Table) and the PMT (Program Map Table) are also packetized by the TS packet 146 unit and multiplexed. The PAT among them stores a table indicating a plurality of PMT packet IDs. Particularly, the PAT is defined by MPEG2 standard so that (000) is given as a predetermined packet ID, as shown in FIG. 12. That is, from among a plurality of packets multiplexed at the same time point, the TS packet 146 obtained by packetizing the PAT is detected, as the TS packet 146 whose packet ID is (000). The PMT stores a table indicating the packet ID for each elementary stream forming each program in one or more programs. Any packet ID can be given to the PMT, their packet IDs are indicated by the PAT detectable with the packet ID (000) as mentioned above. Therefore, among a plurality of packets multiplexed at the same time point, the TS packets 146 obtained by packetizing the PMT (i.e. TS packets 146 to which packet IDs (100), (200) and (300) are given in FIG. 12) are detected on the basis of the PAT.

In the case that the transport stream as shown in FIG. 12 is transferred digitally, the tuner refers to the PAT and the PMT constructed as such and thereby extracts the multiplexed packets corresponding to the desired elementary stream and decodes the extracted packets.

In this embodiment, these PAT and PMT are included as the TS packets 146 to be stored in the TS object 142 shown in FIG. 10. That is, when the transport stream as shown in FIG. 12 is transferred, the transferred stream can be directly recorded onto the optical disc 100, which is a great advantage.

Furthermore in this embodiment, these PAT and PMT recorded as such are not referred to when the optical disc 100 is reproduced. Instead, referring to the AU table 131 and the ES map table 134, shown in FIG. 3 and mentioned in detail later, makes it possible to perform the reproduction effectively and apply to the complicated multi-vision reproduction or the like. For this, in this embodiment, a relationship between packets and the elementary stream obtained by referring to the PAT and the PMT on decoding or recording for example is stored in the object information file 130, in a form of AU table 131 and ES map table 134, without packetizing or multiplexing.

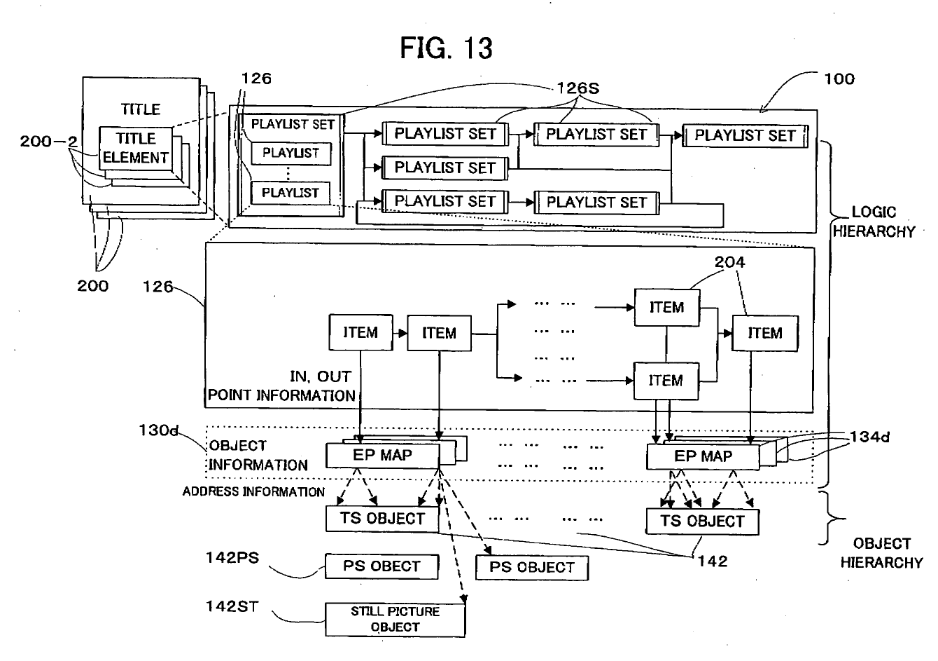

Next, with reference to FIG. 13, the logical structure of data on the optical disc 100 is discussed. FIG. 13 schematically illustrates the logical structure of data on the optical disc 100, focusing on the development from the logic hierarchy to the object hierarchy or the entity hierarchy.

In FIG. 13, one or more titles 200 that are a logical large unit such as one movie or one TV program are recorded on the optical disc 100. Each title 200 includes one or more title elements 200-2. Each title element 200-2 logically consists of a plurality of play list sets 126S. In each title element 200-2, the plurality of play list sets 126S may have a sequential structure or may have a branch structure.

Incidentally, in the case of a simple logical structure, one title element 200-2 consists of one play list set 126S. Furthermore, one play list set 126S consists of one play list 126. On the other hand, it is possible to refer to one play list set 126S by a plurality of title elements 200-2 or a plurality of titles 200.

Each play list 126 is logically made of a plurality of items (play items) 204. In each play list 126, a plurality of items 204 may have the sequential structure or may have the branch structure. On the other hand, it is possible to refer to one item 204 by a plurality of play lists 126. The aforementioned in-point information and out-point information recorded on/in the item 204 logically designates the reproduction range of the TS object 142. Then, the object information 130d of the logically designated reproduction range is referred to and thereby the reproduction range of the TS object 142 is physically designated, via the file system finally. Here, the object information 130d includes various information to reproduce the TS object 142, such as the attribute information of the TS object 142, the ES address information 134d and the like required for the data search in the TS object 142 (Incidentally, the ES map table 134 shown in FIG. 3 includes a plurality of ES address information 134d).

Then, when the information record and reproduce apparatus reproduces the TS object 142 as mentioned below, a physical address to be reproduced in the TS object 142 is obtained from the item 204 and the object information 130d so that a desired elementary stream is reproduced.

Incidentally, the EP (Entry Pass) map including a plurality of ES address information 134d, shown within the object information of FIG. 13, herein indicates an object information table in which the AU table 131 and the ES map table 134 are listed.

Thus, in this embodiment, the in-point information and out-point information recorded on/in the item 204, as well as the ES address information 134d recorded in the ES map table 134 (see FIG. 3) of the object information 130d make it possible to perform the association from the logic hierarchy to the object hierarchy in the reproduction sequence so that the elementary stream is reproduced.

As discussed above, in this embodiment, units of the TS packet 146 are multiplexed and recorded on the optical disc 100. Thereby, the transport stream including a plurality of elementary streams as shown in FIG. 2(b) can be recorded onto the optical disc 100. In this embodiment, in the case that digital broadcasting is recorded onto the optical disc 100, a plurality of programs can be recorded at the same time, within the restriction of the record rate. Nevertheless, a record method is employed herein, in which a plurality of programs are multiplexed and recorded for one TS object 142. Now, an explanation is made on an embodiment of the information record reproduction apparatus capable of performing such a record processing.

(Information Record Reproduction Apparatus)

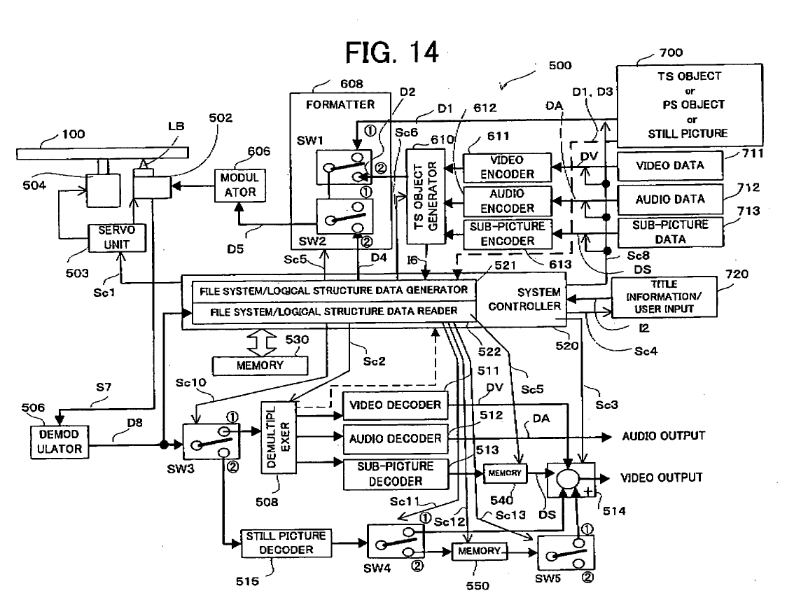

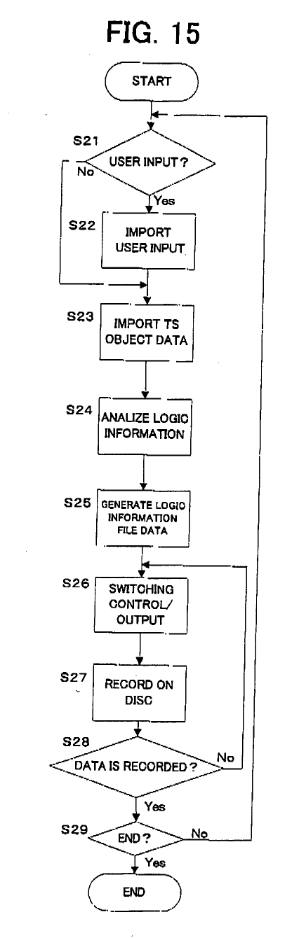

Next, with reference to FIG. 14 to FIG. 19, an embodiment of the information record reproduction apparatus of the present invention is discussed. Here, FIG. 14 is a block diagram of the information record reproduction apparatus, and FIGS. 15 to 19 illustrate the operational flow.

In FIG. 14, the information record reproduction apparatus 500 is roughly divided into a reproduction system and a record system. The apparatus 500 is constructed to record the information onto the optical disc 100 mentioned above and reproduce the information recorded thereon/therein. In this embodiment, the information record reproduction apparatus 500 is thus for recording and reproduction. Nevertheless, an embodiment of the information record apparatus according to the present invention can be constructed basically with the record system of the apparatus 500 and an embodiment of the information reproduction apparatus according to the present invention can be constructed basically with the reproduction system of the apparatus 500.

The information record reproduction apparatus 500 is provided with: an optical pickup 502; a servo unit 503; a spindle motor 504; a decoder 506; a demultiplexer 508; a video decoder 511; an audio decoder 512; a sub-picture decoder 513; an adder 514; a still picture decoder 515; a system controller 520; a memory 530; a memory 540; a memory 550; a modulator 606; a formatter 608; a TS object generator 610; a video encoder 611; an audio encoder 612; and a sub-picture encoder 613. The system controller 520 includes a file system/logical structure data generator 521 and a file system/logical structure data reader 522. Furthermore, the memory 530 and a user interface 720 to give a user input such as title information are connected to the system controller 520.

Among these constitutional elements, the decoder 506, the demultiplexer 508, the video decoder 511, the audio decoder 512, the sub-picture decoder 513, the adder 514, the still picture decoder 514, the memory 540 and the memory 550 mainly constructs the reproduction system. On the other hand, among these constitutional elements, the modulator 606, the formatter 608, the TS object generator 610, the video encoder 611, the audio encoder 612 and the sub-picture encoder 613 mainly constructs the record system. The optical pickup 502, the servo unit 503, the spindle motor 504, the system controller 520, the memory 530 and the user interface 720 to give the user input such as title information are generally shared for both the reproduction system and the record system. Furthermore, for the record system, a TS object data source 700 (or a PS object data source 700, or a still picture data source 700 such as bit map data, JPEG data and the like); a video data source 711; an audio data source 712; and a sub-picture data source 713 are prepared. Furthermore, the file system/logical structure data generator 521 disposed in the system controller 520 is used mainly in the record system, and the file system/logical structure reader 522 is used mainly in the reproduction system.

The optical pickup 502 irradiates the optical disc 100 with a light beam LB such as a laser beam, at the first power as reading light for the reproduction, and at the second power with the light beam LB being modified as writing light for recording. The servo unit 503 performs the focus servo, the tracking servo and the like for the optical pickup 502, as well as the spindle servo for the spindle motor 504, under control of the control signal Sc1 outputted from the system controller 520, during the reproduction and recording. The spindle motor 504 is controlled under the spindle servo by the servo unit 503, for rotating the optical disc 100 at a predetermined speed.

(i) Structure and Operation of Record System

Next, with reference to FIG. 14 to FIG. 18, a specific structure and the operation of each constitutional element constructing the record system of the information record and reproduction system 500 is explained in each case.

(i-1) In the Case that the Already Generated Object is Used

This case is discussed, with reference to FIG. 14 and FIG. 15.

In FIG. 14, the TS object data source 700 may be made of the memory storage such as a video tape, a memory, for storing the TS object data D1.

Firstly in FIG. 15, each title information (e.g. play list contents etc.) to be logically constructed on the optical disc 100 using the TS object data D1 is inputted into the system controller 520, as the user input I2 such as the title information, via the user interface 720. Then, the system controller 520 imports the user input I2 such as the title information via the user interface 720 (step S21: Yes, and step S22). In this case, the user interface 720, under control of the control signal Sc4 from the system controller 520, can perform the input operation in response to the contents to be recorded, such as the selection via the title menu screen. Incidentally, if the user input is already performed (step S21: No), these processings are omitted.

Next, the TS object data source 700 outputs the TS object data D1, under control of the control signal Sc8 to indicate the data reading from the system controller 520. Then, the system controller 520 imports the TS object data D1 from the TS object data source 700 (step S23), and performs the data array analysis (e.g. a record data length and the like) of the TS object data D1, the analysis of each elementary stream structure (e.g. understanding of ES_PID (elementary stream/packet identification number)), on the basis of the PAT, the PMT and the like packetized with the video data as mentioned above, due to the TS analysis feature in the file system/logical structure data generator 521 (step S24).

Next, the system controller 520 makes the file system/logical structure data generator 521 generate the disc information file 110, the play list information file 120, the object information file 130 and the file system 105 (see FIG. 3), as the logical information file data D4, on the basis of the analysis result of each elementary stream and the TS object data D1 data array, as well as the user input I2 such as the imported title information (step S25). The memory 530 is used to generate this logical information file data D4.

Incidentally, variations in which the data about each elementary stream structure information and the TS object data D1 data array may be prepared in advance are naturally understood or suggested, all of which are encompassed within a scope of the embodiment.

In FIG. 14, the formatter 608 is for formatting the data array to store both the TS object data D1 and the logical information file data D4 on the optical disc 100. More specifically, the formatter 608 is provided with a switch Sw1 and a switch Sw2 and is switching-controlled by a switch control signal Sc5 from the system controller 520. When formatting the TS object data D1, it connects the switch Sw1 to a \textcircled{4} side and the switch Sw2 to the \textcircled{1} side so as to output the TS object data D1 from the TS object data source 700. Incidentally, the transmission control of the TS object data D1 is performed by the control signal Sc8 from the system controller 520. On the other hand, when formatting the logical information file data D4, the formatter 608 is switching-controlled by the switch control signal Sc5 from the system controller 520, and connects the switch Sw2 to a \textcircled{2} side so as to output the logical information file data D4.

At step S26 in FIG. 15, (i) the logical information file data D4 from the file system/logical structure data generator 521 at the step S25 or (ii) the TS object data D1 from the TS object data source 700 is outputted through the formatter 608, under the switching-control by the formatter 608 as constructed above (step S26).

The selection output from the formatter 608 is transmitted to the modulator 606 as disc image data D5, and modulated by the modulator 606, and recorded onto the optical disc 100 through the optical pickup 502 (step S27). The system controller 520 also executes the disc record control in this case.

Then, if both the logical information file data D4 generated at the step S25 and the corresponding object data D1 have not been completely recorded yet, the operational flow returns to the step S26 to continue the recording (step S28: No). Incidentally, there is no preference in the record sequence of the logical information file data D4 and the corresponding object data D1.

On the other hand, if the both have been already recorded, it is judged whether or not the recording onto the optical disc 100 is to be ended, on the basis of the presence or absence of an end command (step S29). If it is not to be ended (step S29: No), the operational flow returns to the step S21 to continue the recording. On the other hand, if it is to be ended (step S29: Yes), a series of record processing ends.

As described above, the information record reproduction apparatus 500 performs the record processing in the case of using the already prepared TS object.

Incidentally, the example in FIG. 15 shows that the logical information file data D4 and the corresponding object data D1 are outputted at the step S26, after preparing the logical information file data D4 at the step S25. However, it is also possible to output the object data D1 and/or record the object data D1 onto the optical disc 100 before the step S25, so that the logical information file data D4 is generated and/or recorded after or in parallel with this recording.

Additionally, a PS object data-source or a still picture data source may be used instead of the TS object data source 700. In this case, the recording processing the same as in the case of the TS object data D1 as mentioned above is performed for the PS object data, or the sill picture data such as bit map data, JPEG data and the like, instead of the TS object data D1. Furthermore, instead of the TS object 142, the PS object data or the still picture data is stored in the object data file 140. Then, various logic information about the PS object data or the still picture data is generated under control of the system controller 520, and stored in the disc information file 110, the play list information file 120, the object information file 130 and the like.

(i-2) The Case of Receiving and Recording the Transport Stream on Air

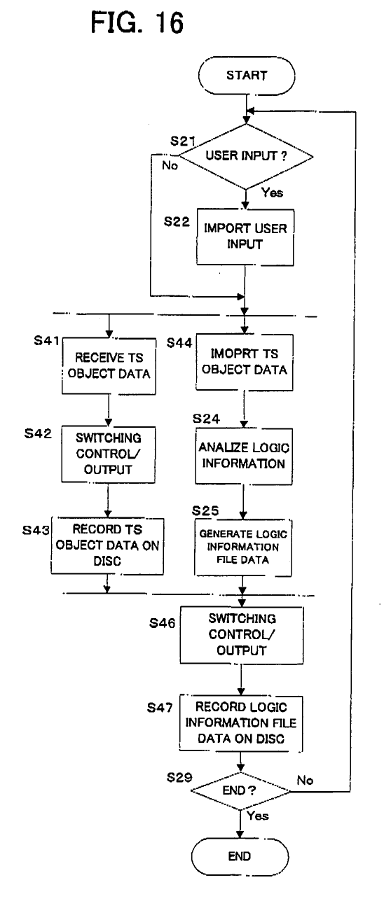

This case is explained with reference to FIG. 14 and FIG. 16. Incidentally, in FIG. 16, the same steps as those in FIG. 15 have the same step reference numbers, and their explanation is omitted as occasion demands.

Again, in this case, the similar processing is performed, as is “the case of using the already prepared object” described above. Therefore, the following explanation is focused on the differences from this case.

In the case of receiving and recording the transport stream on air, the TS object data source 700 is provided with a receiver (set top box) for receiving the digital broadcast on air, for example, receives the TS object data D1, and transmits it to the formatter 608 in real time (step S41). At the same time, reception information D3 (i.e. information corresponding to the data transmitted through the receiver and the interface of the system controller 520) including the program construction information and the belowmentioned ES_PID information, which are deciphered upon receiving, is imported into the system controller 520 and is stored into the memory 530 (step S44).

In the meantime, the TS object data D1 outputted to the formatter 608 is outputted to the modulator 606 under the switching-control by the formatter 608 (step S42), and is recorded onto the optical disc 100 (step S43).

Along with these operations, using the program construction information and the ES_PID information included in the reception information D3 imported upon receiving and stored in the memory 530, the file system/logical structure data generator 521 prepares the logical information file data D4 (step S24 and step S25). Then, after the completion of recording a series of the TS object data D1, this logical information file data D4 is additionally recorded onto the optical disc 100 (step S46 and step S47). Incidentally, these steps S24 and S25 may be performed after the step S43.

Moreover, as the occasion demands (e.g. in the case of editing one portion of the title, or the like), by adding the user input 12 of the title information and the like from the user interface 720 to the program construction information and the ES_PID information stored in the memory 530, it is possible to prepare the logical information file data D4 by the system controller 520 and additionally record this onto the optical disc 100.

As described above, the information record reproduction apparatus 500 performs the record processing in the case of receiving the transport stream on air and recording it in real time.

Incidentally, if all the reception data obtained when broadcasting is once stored into an archive apparatus, and then, if this is used as the object source 700, the same processing as that in “the case of using the already prepared object” will do.

(i-3) The Case of Recording the Video data, the Audio Data and the Sub-Picture Data

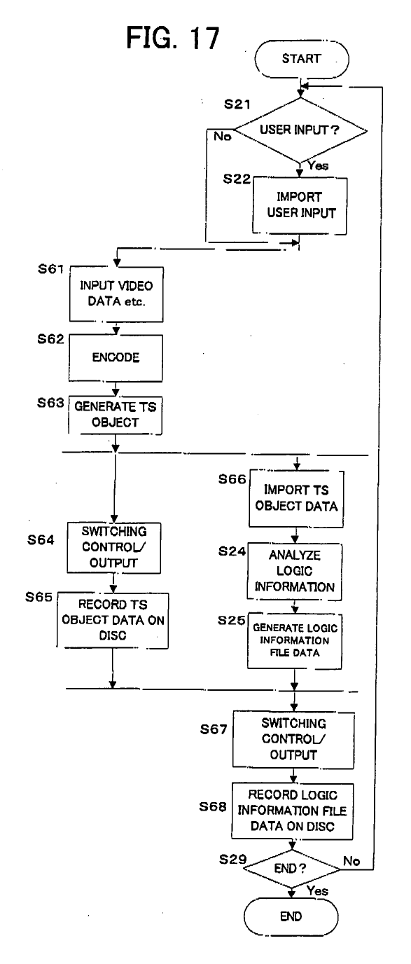

This case is explained with reference to FIG. 14 and FIG. 17. Incidentally, in FIG. 17, the same steps as those in FIG. 15 have the same step reference numbers, and their explanation is omitted as occasion demands.

In the case of recording the video data, the audio data, and the sub-picture data, which are individually prepared in advance, the video data source 711, the audio data source 712, and the sub-picture data source 713 are individually provided with the memory storage, such as a video tape and a memory, and store a video data DV, an audio data DA, and a sub-picture data DS, respectively.

These data sources are controlled by the control signal Sc8 giving an instruction for reading out the data from the system controller 520, and they transmit the video data DV, the audio data DA, and the sub-picture data DS, to the video encoder 611, the audio encoder 612, and the sub-picture encoder 613, respectively (step S61). Then, the video encoder 611, the audio encoder 612, and the sub-picture encoder 613 execute a predetermined type of encode processing (step S62).

The TS object generator 610 is controlled by a control signal Sc6 from the system controller 520 and converts the data encoded in this manner to the TS object data constituting the transport stream (step S63). In this case, the data array information of each TS object data (e.g. a record data length and the like) and the construction information of each elementary stream (e.g. the ES_PID, as described later, and the like) are transmitted as information I6 from the TS object generator 610 to the system controller 520 and are stored into the memory 530 (step S66).

On the other hand, the TS object data generated by the TS object generator 610 is transmitted to the \textcircled{2} side of the switch Sw1 of the formatter 608. Namely, when formatting the TS object data from the TS object generator 610, the formatter 608 is switching-controlled by the switch control signal Sc5 from the system controller 520 to shift the switch Sw1 to the \textcircled{2} side and the switch Sw2 to the \textcircled{1} side, thereby outputting the TS object data (step S64). Then, this TS object data is recorded onto the optical disc 100 through the modulator 606 (step S65).

Along with these operations, using the data array information of each TS object data and the construction information of each elementary stream imported as the information I6 into the memory 530, the file system/logical structure data generator 521 prepares the logical information file data D4 (step S24 and step S25). Then, after the completion of recording a series of the TS object data D2, the logical information file data D4 is additionally recorded onto the optical disc 100 (step S67 and step S68). Incidentally, the step S24 and the step S25 may be processed after the step S65.

Moreover, as the occasion demands (e.g. in the case of editing one portion of the title), by adding the user input 12 such as the title information and the like from the user interface 720 to these information stored in the memory 530, it is possible to prepare the logical information file data D4 by the file system/logical structure generator 521 and additionally record this onto the optical disc 100.

As described above, the information record reproduction apparatus 500 performs the record processing in the case of recording the video data, the audio data, and the sub-picture data, which are individually prepared in advance.

Incidentally, this record processing is applicable even when recording an arbitrary content the user has.

(i-4) The Case of Recording the Data by Authoring

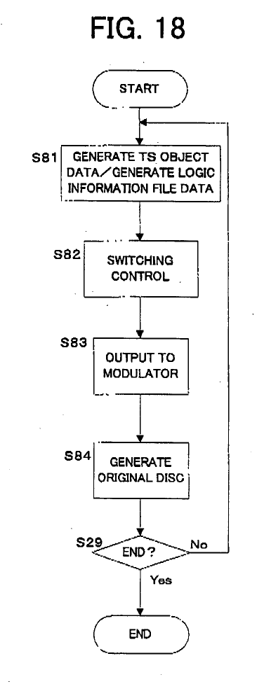

This case is explained with reference to FIG. 14 and FIG. 18. Incidentally, in FIG. 18, the same steps as those in FIG. 15 have the same step reference numbers, and their explanation is omitted as occasion demands.

In this case, by combining the above described three types of record processing in the three cases, an authoring system generates the TS object, the logical information file data, and the like in advance (step S81), and then completes the processing until switching-control performed at the formatter 608 (step S82). Then, the information obtained by this operation is transmitted, as the disc image data D5, to the modulator 606 equipped in front of and/or behind an original disc cutting machine (step S83), and this cutting machine prepares the original disc (step S84).

(ii) Structure and Operation in Reproduction System

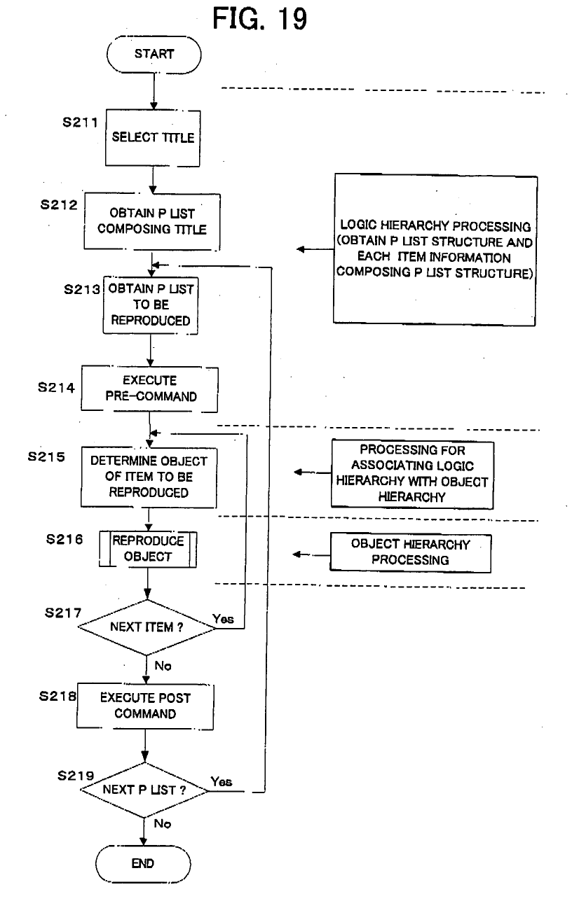

Next, the specific structure and operation of each constitutional element constituting the reproduction system of the information record reproduction apparatus 500 is explained with reference to FIG. 14 and FIG. 19.

In FIG. 14, via the user interface 720, the title to be reproduced from the optical disc 100, its reproduction condition and the like are inputted to the system controller 520, as the user input I2 such as the title information and the like. In this case, under control of the control signal Sc4 from the system controller 520, the input processing suitable for the content to be reproduced, such as a selection on a title menu screen, can be achieved by the user interface 720.

Responding to this, the system controller 520 controls the disc reproduction with respect to the optical disc 100, and the optical pickup 502 transmits a reading signal S7 to the demodulator 506.

The demodulator 506 demodulates a recorded signal recorded onto the optical disc 100 from this reading signal S7, and outputs it as demodulated data D8. The logical information file data (i.e. the file system 105, the disc information file 110, the P list information file 120, and the object information file 130, shown in FIG. 3) included in this demodulated data D8 as being a not-multiplexed information part is supplied to the system controller 520. On the basis of this logical information file data, the system controller 520 executes various reproduction control, such as processing of determining a reproduction address and controlling the optical pickup 502.

On the other hand, depending on whether the TS object data is included as the multiplexed information part in the demodulated data D8, or whether the still picture data is included, or whether both data are included, the shift switch Sw3 is shifted to \textcircled{1} side (demultiplexer 508 side) or shifted to \textcircled{2} side (still decoder 515 side), under control of the control signal Sc10 from the system controller 520. Thereby, the TS object data is selectively supplied to the demultiplexer 508, and the still picture data is selectively supplied to the still picture decoder 515.

Then, as for the TS object data included as the multiplexed information part in the demodulated data D8, the demultiplexer 508 demultiplexes the TS object data, under control of the control signal Sc2 from the system controller 520. Here, when the access to the reproduction position address is terminated under the reproduction control by the system controller 520, the control signal Sc2 is transmitted to start the demultiplexing.

The video packet, the audio packet and the sub-picture packet are transmitted respectively from the demultiplexer 508 and supplied respectively to the video decoder 511, the audio decoder 512 and the sub-picture decoder 513. Then, the video data DV, the audio data DA and the sub-picture data DS are decoded, respectively. In this case, the sub-picture data DS is supplied to the adder 514 via the memory 540. The sub-picture data DS is outputted from the memory 540, selectively or at a predetermined timing, under control of the control signal Sc5 from the system controller 520, so as to be super-imposed on the video data DV, if needed. That is, in comparison with a case that the sub-picture data outputted from the sub-picture decoder 513 is directly super-imposed, it is easy to control the timing of the super-imposing, or to judge the need for the super-imposing. For example, under output control of the control signal Sc5, it is possible to select whether or not a caption using the sub-picture is displayed over the main picture, or whether or not a menu screen using the sub-picture is displayed.

Incidentally, although the packets obtained by packetizing the PAT or the PMT, included in the transport stream shown in FIG. 6, are included as a part of the demodulated data D8, respectively, they are discarded or abandoned at the demultiplexer 508.

The adder 514 is controlled by a control signal Sc3 giving an instruction of the mixing from the system controller 520, and mixes or superimposes in a predetermined timing the video data DV and the sub-picture data DS, which are respectively decoded at the video decoder 511 and the sub-picture decoder 513. The result is outputted as a video output from the information record reproduction apparatus 500 to a TV monitor, for example.

On the other hand, the audio data DA decoded at the audio decoder 512 is outputted as an audio output from the information record reproduction apparatus 500 to an external speaker, for example.

In the case that the still picture data is included in the decoded data D8, the still picture data is supplied to the still picture decoder 515, via the shift switch Sw3 controlled by the control signal Sc10 from the system controller 520, instead of or in addition to such a reproduction operation or processing of the video data DV or the sub-picture data DS. Then, the still picture data such as the decoded bit map data, JPEG data and the like is added to the adder 514 via the shift switch Sw4, without subjected to any processing, under control of the control signal Sc11 from the system controller 520. Alternatively, it may be temporarily stored in the memory 550 via the shift switch Sw4. The still picture data is outputted from the memory 550, selectively or at a predetermined timing, under control of the control signal Sc12 from the system controller 520, and then supplied to the adder 514 via the shift switch Sw5. Thereby, if needed, the video data DV or the sub-picture data DS is super-imposed over the still picture data or vice versa. That is, in comparison with a case that the still picture data outputted from the still picture decoder 515 is directly super-imposed, it is easy to control the timing of the super-imposing, or to judge the need for the super-imposing. For example, under output control of the control signal Sc12, it is possible to select whether or not a still picture such as a menu screen or a window screen using the still picture data or a still picture as a background image using the still picture data is displayed on the main picture of the sub-picture.

Additionally, under control of the control signal Sc13 from the system controller 520, the still picture data may be outputted via another route (not shown), with the aid of the shift switch Sw5 shifted to \textcircled{2} side. Alternatively, no still picture data may be outputted from the shift switch Sw5 shifted to \textcircled{2} side.

Here, the specific example of a reproduction processing routine by the system controller 520 is explained with reference to a flow chart of FIG. 19.

In FIG. 19, it is assumed that as an initial condition, the recognition of the optical disc 100 in the reproduction system and the recognition of a volume structure and a file structure by the file system 105 (see FIG. 3) have been already completed by the system controller 520 and the file system/logical structure data reader 522 inside of the system controller 520. Here, an explanation is made on the operational flow after obtaining the total number of the total titles from the disc general information 112 in the disc information file 110 and then choosing or selecting one title from among them.

Firstly, the choice or selection of the title is performed via the user interface 720 (step S211). Responding to this, the system controller 520 obtains the information about the reproduction sequence from a reading result of the file system/logical structure data reader 522. Incidentally, in the selection of the title 200, the desired title element(s) 200-2 (see FIG. 4) may be selected from among a whole title elements 200-2 composing the title 200, with the aid of an external input operation by the user with using a remote controller and the like, or one title element 200-2 may be selected automatically depending on a system parameter or the like adjusted for the information record reproduction apparatus 500.

Then, contents of a plurality of play lists 126 composing a play list set 126S corresponding to the selected title 200 (title element 200-2) are obtained. Here, as a processing at a logic hierarchy, the information about the each play list 126 structure and each item composing each play list (see FIG. 5, FIG. 6 and FIG. 13) is obtained (step S212).

Then, contents of the play list 126 to be reproduced is obtained from among a plurality of play lists 126 obtained at step S212. For example, herein, the reproduction is started from a play list #1, and the contents of the corresponding play list 126 is obtained (step S213). The contents of the play list 126 may be one or more play list elements 126-2 (see FIG. 5), which are obtained by the obtaining processing at step S213.

Then, the pre-command 126PR (see FIG. 5) included in this play list 126 is executed (step S214). Incidentally, it is possible for the pre-command 126PR to select one from among a plurality of play lists 126, which composes the play list set 126S with a certain relationship of the plurality of play lists 126. If the play list element 126-2 composing the play list 126 does not have the pre-command 126PR, this processing is omitted.

Then, the TS object 142 (see FIG. 3 and FIG. 10) to be reproduced is determined (step S215), on the basis of the item 204 (see FIG. 5 to FIG. 7) identified by the play list 126 obtained at step S213. More specifically, on the basis of the item 204, the object information file 130 (see FIG. 3) relating to the TS object 142 as the reproduction target is obtained and a stream number, address and the like of the TS object 142 to be reproduced are identified.

Incidentally, in this embodiment, also the belowmentioned AU (Association Unit) information 132I and PU (Presentation Unit) information 302I are obtained as the information stored in the object information file 130. On the basis of these informations, the aforementioned logic hierarchy is associated with the object hierarchy (see FIG. 13).

Then, the reproduction of the TS object 142 determined at step S215 is actually started. That is, on the basis of the processing at the logic hierarchy, the processing at the object hierarchy is started (step S216).

During the reproduction of the TS object 142, it is judged whether or not the next item 204 composing the play list 126 to be reproduced exists (step S217). Then, insofar as the next item 204 exists (step S217: Yes), the process goes back to the step S215 to repeat the aforementioned determination and the reproduction of the TS object 142.

On the other hand, at the judgement at step S217, if it is judged that the next item 204 does not exist (step S217: No), the post command 126PS (see FIG. 5) corresponding to the presently executed play list 126 is executed (step S218). Incidentally, if the play list element 126-2 composing the play list 126 does not have the post command 126PS, this processing is omitted.

Then, it is judged whether or not the next play list 126 composing the selected title 200 exists (step S219). If exists (step S219: Yes), the process goes back to the step S213 to repeat the processings following obtaining the play list 126 to be reproduced.

On the other hand, at the judgement at step S219, if it is judged that the next play list 126 does not exist (step S219: No), i.e. if the all play lists 126 to be reproduced corresponding to the title 200 selected at step S211 are completely reproduced, a series of reproduction operations or processings is terminated.

As discussed above, the information record reproduction apparatus 500 in this embodiment reproduces the optical disc 100.

Particularly in this embodiment, (i) with regard to the structure and operation of the record system mentioned above, the object data file 140 is recorded so that the control information stream or the sub-picture stream that is an elementary stream relating to the sub-picture includes the SP data (still picture data) and the SP control information to scroll the highlighted button.

Particularly in this embodiment, (ii) with regard to the structure and operation of the reproduction system, when the object is determined and reproduced at the steps S215 and S216, the SP data and the SP control information recorded in the sub-picture stream or the control information stream are reproduced. On the basis of these SP data and the SP control information, the highlight button control with the sub-frame can be performed, especially a scroll display control of one or more buttons highlighted or highlightable. Various display controls of such a sub-picture will be described later in detail.

(Selection Scheme of Play List in Play List Set)

In the embodiment, the play list 126 corresponding to the desired content information is selected, as occasion demands, from the play list set 126S which is included in the reproduced play list information file 120.

With respect to such selection of the play list, the pre command 200PR included in the title element 200-2 (see FIG. 4) may be provided with a play list selection command group list in which a selection condition is described, for each play list 126, and the selection of the play list may be performed in accordance with this selection condition. It may be also performed in accordance with the attribute information appended to each play list 126 which is stored in the play list set 126S (e.g. information for indicating the attribute of the content information related to the play list, such as video resolution about a video function, distinction of progressive/interleave, a video codec, the number of audio channels, and an audio codec). Alternatively, it may be also performed in accordance with play list set control information, which is included in the title element 200-2, for storing the selection condition for each play list. By such selection, it is possible to select what corresponds to the desired content information, such as a desired show, a desired parental block, and a desired angle block. Alternatively, for example, it is possible to select such a play list that can be reproduced by the information reproduction system and that fully uses or maximizes the video reproduction function and the audio reproduction function owned by the information reproduction system.

(Scroll Display Control of Highlight Button)

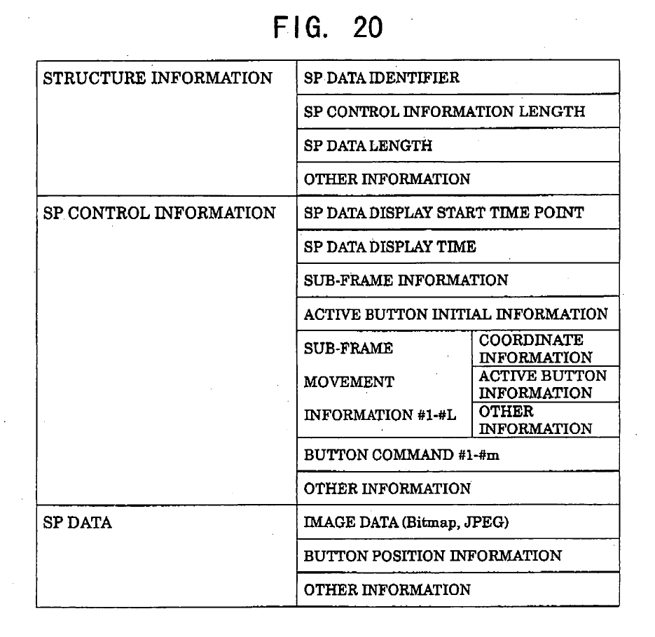

Next, with reference to FIG. 20 to FIG. 28, an explanation is made on a control for displaying a highlighted button inside of the sub-frame displayed at a part of the main video screen area, and further scroll-displaying such a sub-frame while the highlighted button being displayed.

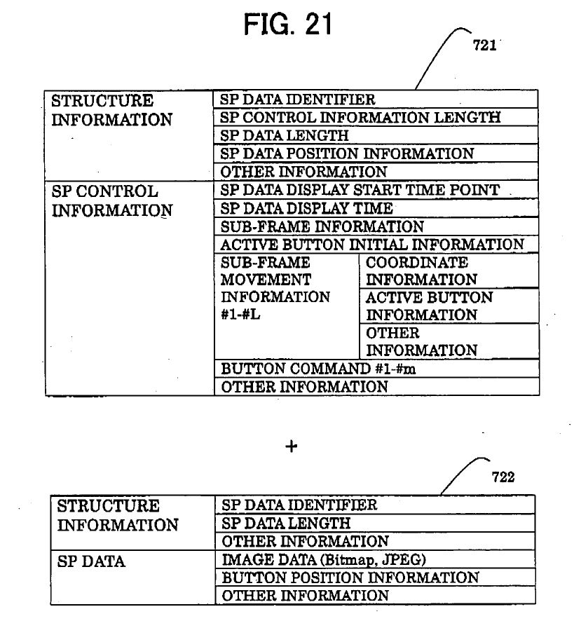

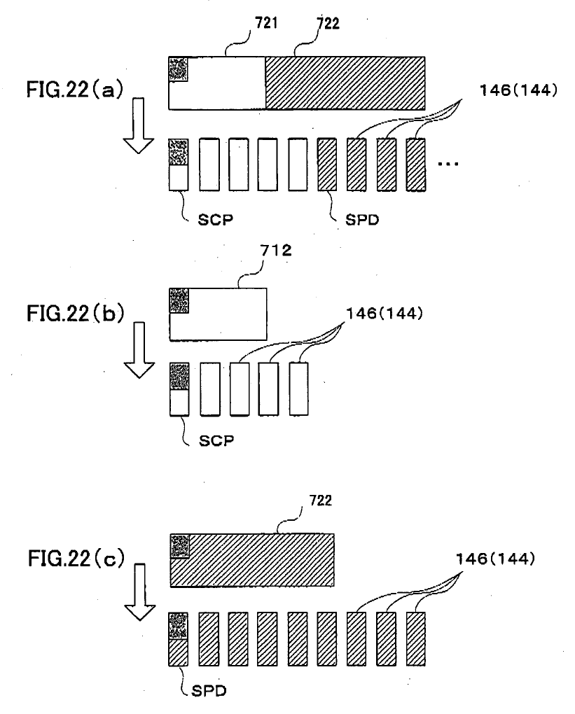

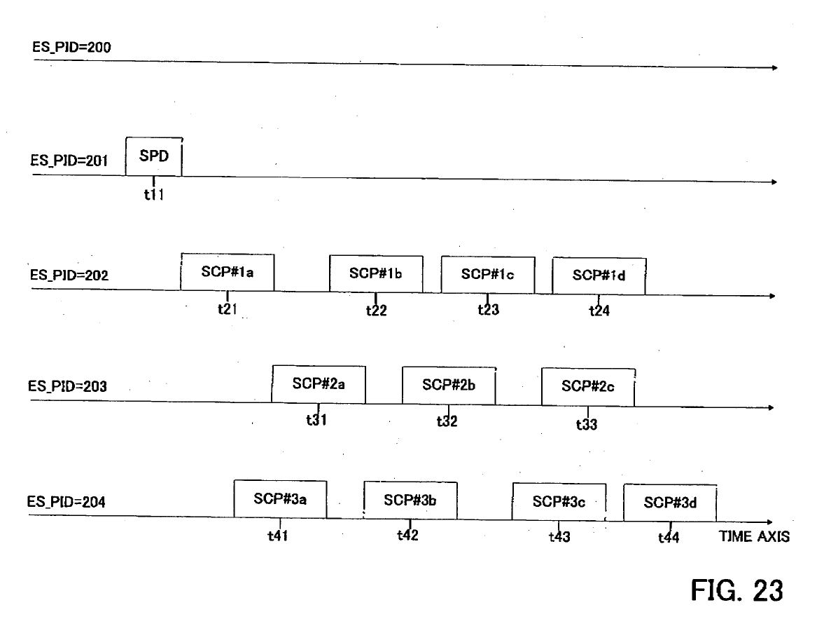

Firstly, with reference to FIG. 20 to FIG. 23, an explanation is made about the structure and control of the sub-picture data used for scroll-displaying the highlighted button as such. FIG. 20 conceptually shows a specific example of the sub-picture structure including the SP data and the SP control information. FIG. 21 conceptually shows another specific example of the sub-picture structure including the SP data and the SP control information. FIG. 22 schematically shows three kinds of sub-picture structure constructed from the sub-picture structures shown in FIG. 20 and FIG. 21. FIG. 23 schematically shows a relationship between the SPD stream and a plurality of SCP streams along the reproduction time axis.

In this embodiment, in FIG. 14, the sub-picture data decoded by the sub-picture decoder 513 is temporarily stored in the memory 540 acting as a buffer. Then, at least one of the SP data (still picture data) and the SP control information (still picture control data), which are included in the temporarily stored sub-picture data is read under control of the control signal Sc5 from the system controller 520. Then, a still picture display is performed as a whole or a part of the video output, by acting the SP control information on the SP data.

As shown in FIG. 20, the sub-picture structure having the highlight information is generally classified into the SP control information and the SP data.

The “structure information”, which acts as a header of the sub-picture structure, includes a SP data identifier such as an identification number for identifying the sub-picture, a data length of the SP control information included in the sub-picture structure, a data length of the SP data included in the sub-picture structure, and other information. The data lengths of the SP control information and the SP data may be variable or constant, respectively.

The “SP control information” comprises various parameters to control the SP data, by the unit of a sub-frame (SF), which is an image part cut out at least partially from an image defined by the SP data. More specifically, the “SP control information” includes a “SP data display start time point” and a “SP data display time” (or “display time end time point”), which are indicated by the PTS (presentation time stamp) or the like, and “sub-frame information” for defining each sub-frame range or the like which is an object to be controlled in the SP data.

Furthermore, the “SP control information” includes “active button initial information”, “sub-frame movement information #1 to #L”, “button command #1 to #L” and “other information”.

From among them, the “active button initial information” is information for designating a selectable (i.e. active) button or a button to be highlighted, when the sub-frame including the button is firstly displayed (initial state).

Each of the “sub-frame movement information #1 to #L” includes (i) “coordinate information” for designating coordinates to which the sub-frame moves by scrolling, (ii) “active button information” for identifying the selectable (i.e. active) button or the button to be highlighted after the movement in accordance with this coordinate information, and (iii) other information, respectively (for each movements).

Each of the “button command #1 to #L” designates a button command to be executed in response to a button operation, for each button. For example, in the case that the sub-frame is scrolled, the command designates how long it will take to execute the movement corresponding to the sub-frame movement information #i.

The “other information” in the SP control information may be various parameters indicating a condition of a sub-frame scaling, a rotational movement, a parallel translation, a shadowing and so on.

On the other hand, the “SP data” may have “image data” in a JPEG format or a bit map data format through a run length encoding for example. Furthermore, the “SP data” has button position information #1 to #n for designating a button position (range) within the sub-frame, for each button, and other information.

The “button position information #1 to #n” may designate each display area of buttons whose total number is “n”, with two corners diagonally opposing to each other of a rectangular area, in the case that the rectangular area is defined as a button for example. These coordinates are indicated in a SP data coordinate system. Furthermore, each button position information includes route information for indicating a route along which a highlight moves (e.g. from top to down) with a user's operation using cursor keys or the like, and highlight pattern information for indicating a highlight display pattern (e.g. brightness, color density, hatching pattern and so on).

Particularly in this embodiment as mentioned above, the “highlight” information“to highlight the button depending on the operational status includes (i) the button position information #1 to #n added to the SP data, (ii) the sub-frame movement information #1 to #L added to the SP control information, and (iii) the button commands #1 to #m added to the SP control information. Incidentally, the reason why the button position information #1 to #n is added to the SP data is to avoid defining redundantly the coordinates of the same button in each SP control information, in the case that the SP control information and the SP data are divided into different streams.

According to this embodiment, since there are provided with the SP control information and the SP data constructed as mentioned above, any area within one SP data can be designated as a sub-frame on the basis of the sub-frame information in the SP control information. Furthermore, any area or areas within this sub-frame can be designated as an area or areas acting as one or more (n) buttons. Then, on the basis of the active button initial information, the sub-frame movement information #i (#1 to #L), the button command #i (#1 to #m) in the SP control information, any button or buttons can be highlighted depending on the operational status, and furthermore the sub-frame can be scrolled with the button or buttons highlighted.

Incidentally, in FIG. 20, the sub-picture structure having the highlight information consists of one data structure including three parts: the structure information; the SP control information; and the SP data. In this embodiment, however, these SP control information and the SP data may be constructed as separate data structures as shown in FIG. 21.

That is, in FIG. 21, the SP control information 721 has the structure information as the header and a main body of the SP control information. On the other hand, the SP data structure 722 has the structure information as the header and a main body of the SP data. The data contents composing the SP control information 721 and the SP data structure 722 respectively are almost the same as the information shown in FIG. 20.

By employing the separate structure shown in FIG. 21, it is easy to divide the SP control information and the SP data into different streams. Furthermore, defining the coordinates of the button corresponding to one SP data in the SP data structure 722 advantageously avoids defining redundantly the coordinates of the same button by the SP control information 721, in the case that a plurality of SP control informations 721 are acted on the SP data in the same SP data structure 722.

As shown in FIGS. 22, the SP control information 721 and the SP data structure 722 are packetized into a plurality of TS packets 146 (refer to FIG. 10) and multiplexed. The TS packet 146 for storing therein the head portion of the SP control information 721 in the sub picture structure is referred to as a “SCP”, and the TS packet 146 for storing therein the head portion of the SP data structure 722 in the sub picture structure is referred to as a “SPD”.

As shown in FIG. 22(a), both the SP control information 721 including the SCP and the SP data structure 722 may be regarded as one sub picture structure and divided into the plurality of TS packets 146. As shown in FIG. 22(b), the SP control information 721 including the SCP may be regarded as one sub picture structure and divided into the plurality of TS packets 146. As shown in FIG. 22(c), the SP data structure 722 including the SPD may be regarded as one sub picture structure and divided into the plurality of TS packets 146.

In the embodiment, for example, with respect to the SP data in the SP data structure 722 recorded on a SPD stream, the SP control information recorded on a SCP stream different from this SPD stream is operated, to thereby perform the reproduction control of the still picture. In this case, there may be only one or a plurality of SCP streams which operates with respect to one SPD stream. Recording the two types of streams onto mutually different elementary streams allows efficient reproduction control. Moreover, operating a plurality of SP control information on a plurality of SCP streams, with respect to the SP data on one SPD stream, allows more efficient reproduction control.

More specifically, as shown in FIG. 23, at a time point t11 during the reproduction of a video stream (Video 1) of “ES_PID=200”, the reading of the SP data (SPD1) on a SPD stream of “ES_PID=201” is started, and it is stored into the memory 540 of the information record reproduction apparatus 500 (refer to FIG. 14). Then, the stored SP data is stored until a set end time point, for example, or is stored until the reading a next sub picture is started.

In FIG. 23, on a SCP stream (SCP1) of “ES_PID=202”, SCP#1a, SCP#1b, SCP#1c, and SCP#1d are provided in timing of a time point t21, a time point t22, a time point t23, and a time point t24, respectively. On a SCP stream (SCP2) of “ES_PID=203”, SCP#2a, SCP#2b, and SCP#2c are provided in timing of a time point t31, a time point t32, and a time point t33, respectively. On a SCP stream (SCP3) of “ES_PID=204”, SCP#3a, SCP#3b, SCP#3c, and SCP#3d are provided in timing of a time point t41, a time point t42, a time point t43, and a time point t44, respectively.

However, in addition to such reproduction control of the still picture, it is possible that with respect to the SP data in the sub picture data structure recorded on the sub picture stream, the SP control information in the sub picture structure recorded on the same stream is operated, to thereby perform the reproduction control of the still picture. Namely, both the SP control information 721 and the SP data structure 722 may be recorded into only one sub picture stream, to thereby operate the SP control information 721 to the SP data structure 722.

In any case, by sharing or using many times the SP data provided as the bit map data and JPEG data which have a large data amount, it is possible to save a limited recording capacity on the disc, which allows more efficient reproduction and display processing. In addition, in any case, it is possible to superimpose such a sub picture onto a moving picture or video which is based on the video data recorded in another video stream.

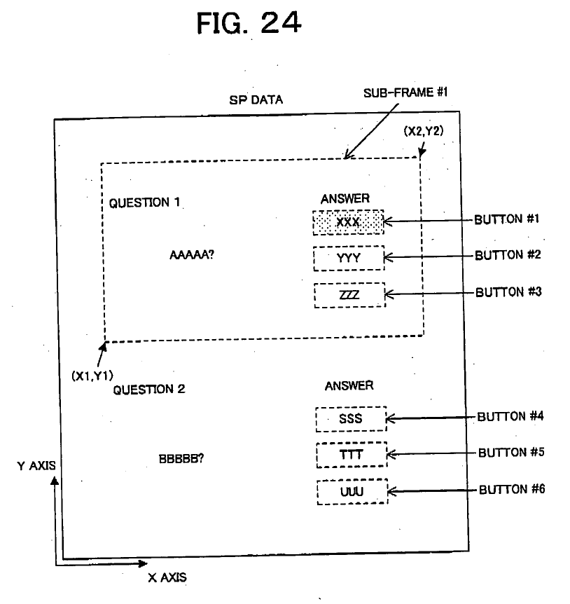

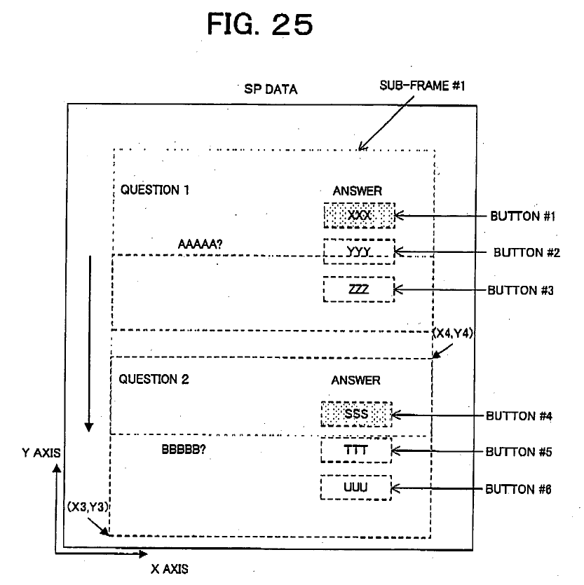

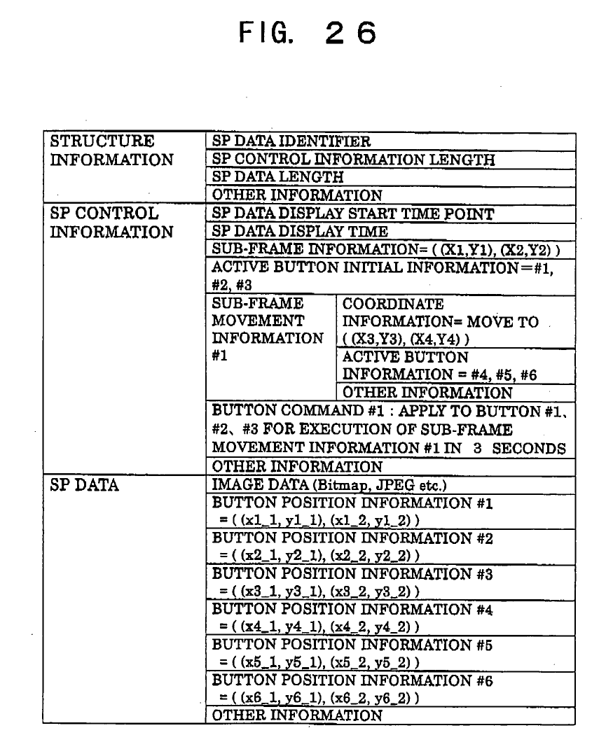

Now, with reference to FIG. 24 to FIG. 26, an explanation is made on a specific example of a control in scrolling the highlight button with using the SP control information and the SP data constructed as such. FIG. 24 and FIG. 25 show sub-frame cut out positions and button design positions relative to the SP data, and buttons to be highlighted, when the scroll of the highlighted buttons is controlled. FIG. 26 shows a specific example of data contents of the SP control data and the SP data corresponding to the case of FIG. 24 and FIG. 25.

In FIG. 24, the SP data indicates the still picture including “question 1” and “question 2”, as well as the corresponding answer candidates, respectively. The sub-frame #1 is defined in the SP data by the sub-frame information.

Specifically, for example, coordinates (X1, Y1) and (X2, Y2) of two corners of the rectangular sub-frame #1, are designated by the sub-frame information ((X1, Y1), (X2, Y2)) in the SP control information shown in FIG. 26. Positions of buttons #1 to #6 are designated in the SP data, by the button position information #1 to #6 in the SP data show in FIG. 26. Such a positional designation of the button is fixed by the button position information, regardless of the sub-frame position. In general, button design parts included in the SP data, or parts to be served as buttons, are designated as buttons by the button position information. In this example, rectangular portions including the “answer” parts are designated as buttons #1 to #6, respectively. From among them, three buttons #1 to #3 are included in the sub-frame 1.

In the case that such a sub-frame #1 is cut out from the SP data, and is then displayed in a predetermined area on the main video screen, the buttons #1, #2 and #3 firstly become selectable on the basis of the active initial button information (=#1, #2 and #3) in the SP control information, while the button #1 is highlighted in the initial state (hatched portion in FIG. 24). At this stage, from among the SP data shown in FIG. 24, the “question 1” and the corresponding three “answer” candidates parts in the cut out sub-frame #1 are only displayed in the predetermined area on the main video, while the “question 2” and the corresponding three “answer” candidates are not displayed in the predetermined area on the main video (i.e. non-visible to the user). Therefore, the user is to select a desired “answer” candidate corresponding to the “question 1” through a remote control, a panel control or an audio input operation, and so on.

Then, as shown in FIG. 25, the sub-frame #1 is scrolled or moved in accordance with the sub-frame movement information #1, a button command relating to a scroll command in the SP control information or the like, in response to the scroll command inputted by the user who completes answering to the “question 1” for example, or in the case that a special condition is satisfied, which is preset by the contents author (e.g. a condition that an answer is inputted to the “question 1”, or a condition that no answer is inputted to the “question 1” during a predetermined time period.). Such a movement of the sub-frame #1 is performed relative to the SP data. For example, as shown by an arrow in FIG. 25, if the sub-frame #1 is moved from top to down, the sub-picture in a fixed area of the main video screen where the cut out sub-frame #1 is displayed is moved from down to top, in other words, scrolled from down to top.

In accordance with the sub-frame information (i.e. the coordinate information, the active button information and so on) in the SP control information, the sub-frame #1 is moved. As a result, buttons #4, #5 and #6 defined by the button position information (#4 to #6) added to the SP data are displayed as the sub-picture. Particularly, during the movement of the sub-frame #1, i.e. while the sub-picture including the highlighted button is scrolled, the position information of buttons on the SP data is identified by the button position information in the SP data, and how to scroll the sub-picture is identified by the sub-frame movement information and the like (see FIG. 26). Therefore, regardless of the position of the sub-frame #1 during the movement, the button positions, especially the position of the button to be highlighted, included in the sub-frame #1 at each time point are uniquely defined by the SP control information and the SP data shown in FIG. 26. That is, even during the scroll movement, it is avoided that the area to be highlighted in the sub-frame deviates from the button, so that a status in which a specific button is highlighted is appropriately maintained on the display screen, while the scroll is performed.

For example, in the specific example of FIG.25, the button #1 remains highlighted during the scrolling. Then, at a scroll end time point, a time point when the button #1 deviates from the sub-frame #1, or a time point when the button #3 enters the sub-frame #1, highlighting the button is terminated. Simultaneously with this, or immediately before or after this, the button #3 is started to be highlighted. I Furthermore, the movement completes or almost completes as described above, an initial status in which buttons #1 to #3 are selectable while the button #1 is highlighted (or a status in which the button #2 or #3 is highlighted depending on the cursor operation after then) is changed, in accordance with the “active button information” in the SP control information shown in FIG. 26, to a status in which the buttons #4 to #6 are selectable while the button #4 is highlighted by default. That is, by making a change to the button to be highlighted in accordance with the scrolling, it is possible to avoid a meaningless continuation of the highlight display control in the SP data, which has disappeared from the screen along with the movement of the sub-frame #1, with the scrolling, and it is possible to highlight with a good timing an appropriate button from among buttons appeared in the screen.

The scrolling display of the highlighted button discussed above is achieved generally as follows in the information record reproduction apparatus 500 shown in FIG. 14. That is, the SP data and the SP control information are reproduced as a part of the sub-picture by the sub-picture decoder 513, and the image data (still picture data) is stored into the memory 540. Then, on the basis of the button command information, the highlight information, the button information, and the sub-frame information and so on included in the SP control information or the like as mentioned above, the output content and timing of the image data from the memory 540 (e.g. sub-frame coordinates, scrolling time, highlight button number and so on) are performed under control of the control signal Sc5 from the system controller 520. The sub-picture including highlighted button reproduced as such is superimposed on a predetermined area of the video image by the adder 514 and is then outputted.

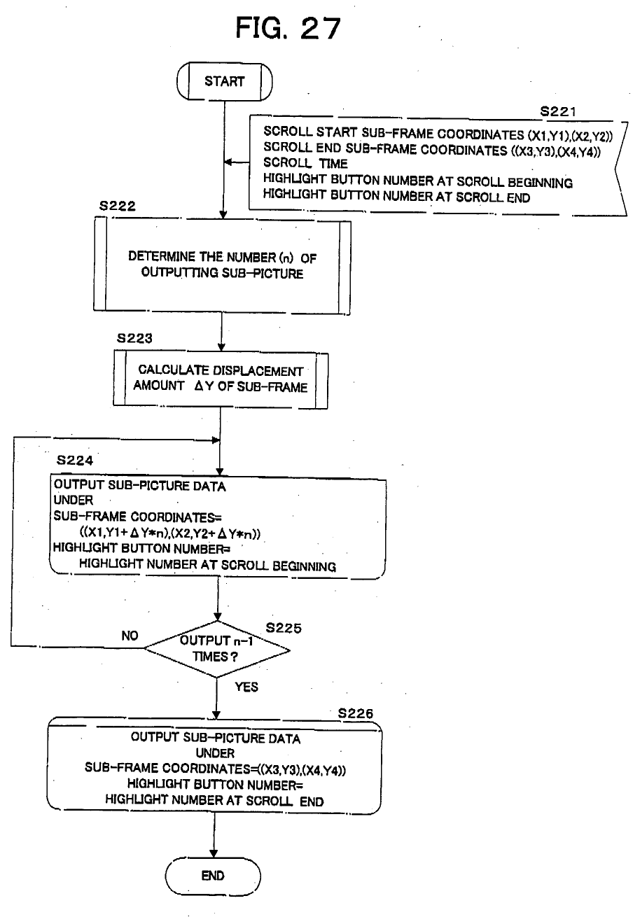

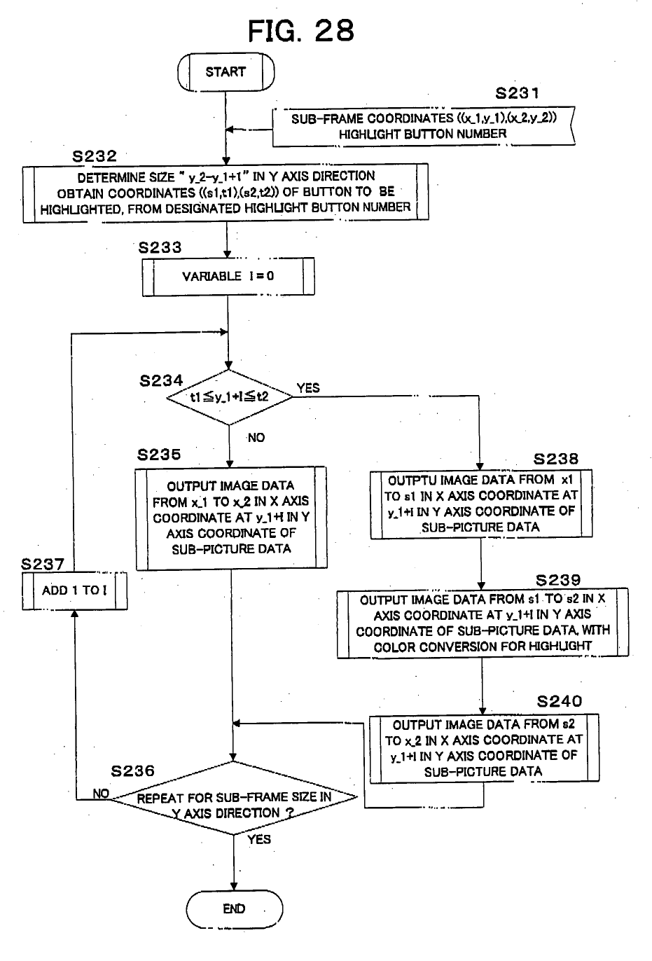

Now, with reference to FIG. 27 and FIG. 28, an explanation is made on a reproduction output processing of the sub-picture data, including scrolling the highlighted button as mentioned above. FIG. 27 is a flow chart showing a scroll display processing of the highlighted button, mainly relating to a processing part of determining a displacement amount of the sub-frame and outputting display data of the sub-picture. FIG. 28 is another flow chart showing the scroll display processing of the highlighted button, mainly relating to a processing part of highlighting a specific button in the sub-frame and outputting it to the adder.

Firstly in FIG. 27, during the reproduction of the optical disc 100, the sub-picture decoder 513 decodes the sub-picture stream to obtain the SP control information and the SP data (see FIG. 20, FIG. 26 and so on). Thereby, the system controller 520 obtains the scroll start sub-frame coordinates ((X1, Y1), (X2, Y2)), the scroll end sub-frame coordinates ((X3, Y3), (X4, Y4)), the scroll time, the button information indicating the highlight button number at the scroll start, the highlight button number at the scroll end and the like, and the highlight information, as shown in FIG. 26 (step S221).

Then, the system controller 520 determines the number (n) of outputting the sub-picture, for example, on the basis of a frame rate of the video signal decoded by the video decoder 511 and the scroll time obtained at the step S221 (step S222).

Then, the system controller 520 determines an amount (Δ Y) for moving the sub-frame by one frame, from a mathematical formula, Δ Y=Y3−Y1 (step S223).

Then, the system controller 520 calculates the sub-frame coordinates of each frame of the video signal, from a definition ((X1, Y1+Δ Y*n), (X2, Y2+Δ Y*n)). Furthermore, the system controller 520 performs a control with the control signal Sc5 to output the sub-picture from the memory 540, so that the sub-picture is outputted on the basis of the highlight number as the highlight number at the scroll start (step S224).

Then, it is judged whether or not the sub-picture is outputted by (n-1) times (step S225). If it is not outputted by (n-1) times (step S225: No), the process flow goes back to the step S224 to repeat the subsequent processings. Thereby, as the number of outputting the sub-picture increases, the sub-frame coordinates gradually moves from ((X1, Y1), (X2, Y2)) to ((X3, Y3), (X4, Y4)).

At the judgement at the step S225, if it is judged that the sub-picture is outputted by (n-1) times (step S225: Yes), the system controller 520 performs a control with the control signal Sc5 to output the sub-picture from the memory 540, so that the sub-picture is outputted on the basis of the highlight number as the highlight number at the scroll end (step S226).

Consequently, the scroll display can be achieved with a displacement amount (Δ Y) of the sub-frame for one frame of the video signal. Furthermore, in this case, the scrolling is performed while the button to be highlighted remains highlighted.

Firstly in FIG. 28, during the reproduction of the optical disc 100, the sub-picture decoder 513 decodes the sub-picture stream to obtain the SP control information and the SP data (see FIG. 20, FIG. 26 and so on). Thereby, the system controller 520 obtains the highlight button number having the designated sub-frame coordinates ((x1, y1), (x2, y2)), as shown in FIG. 26 (stepS231).

Then, the system controller 520 determines a size in the Y axis direction, “y_{—}2−y_{—}1+1”. Then, the coordinates of the button to be highlighted, ((st, t1), (s2, t2)), is identified from the highlight number designated at the step S231 (step S232).

Then, a variable “I” to control the highlight when each frame is displayed during the scrolling is set to “0” (step S233).

Then, the system controller 520 judges whether or not a following inequality is satisfied (step S234).
t1≦y_{—}1+I≦t2

At the judgement of the step S234, if the aforementioned inequality is not satisfied (step S234: No), the image data is outputted into an area from X axis coordinate “x_{—}1” to “x_{—}2” at a Y axis coordinate “y_{—}1+I” of the sub-picture data (step S235). Then, the process flow goes to a step S236.

On the other hand, at the judgement of step S234, if the aforementioned inequality is satisfied (step S234: Yes), a control is performed to output from the memory 540 the image data in an area from X axis coordinate “x_{—}1” to “s1” at Y axis coordinate “y_{—}1+I” of the sub-picture data (step S238).

Then, a control is performed to apply color conversion for the highlight relative to the image data in an area from X axis coordinate “s1” to “s2” at Y axis coordinate “y_{—}1+I” of the sub-picture data and output it from the memory 540 (step S239).

Furthermore, a control is performed to output from the memory 540 the image data in an area from X axis coordinate “s2” to “x2” at Y axis coordinate “y_{—}1+I” of the sub-picture data (step S240). Then, the process flow goes to the step S236.

Then, at the step S236, the system controller 520 judges whether or not it is repeated for a size of the sub-frame in the Y axis direction (step S236). If it is repeated for a size of the sub-frame in the Y axis direction (S236: Yes), a series of processings ends.

On the other hand, at the judgement of the step S236, if it is judged that it is not repeated for a size of the sub-frame in the Y axis direction (S236: No), the variable “I” is incremented by “1”. After then, the process flow goes back to the step S234 to repeat the subsequent processings.

As shown from FIG. 20 to FIG. 28, according to this embodiment, a highlight button control can be achieved with the sub-frame, especially a scroll display can be achieved for one or more buttons highlightable or highlighted.

(Access Flow on Reproduction)

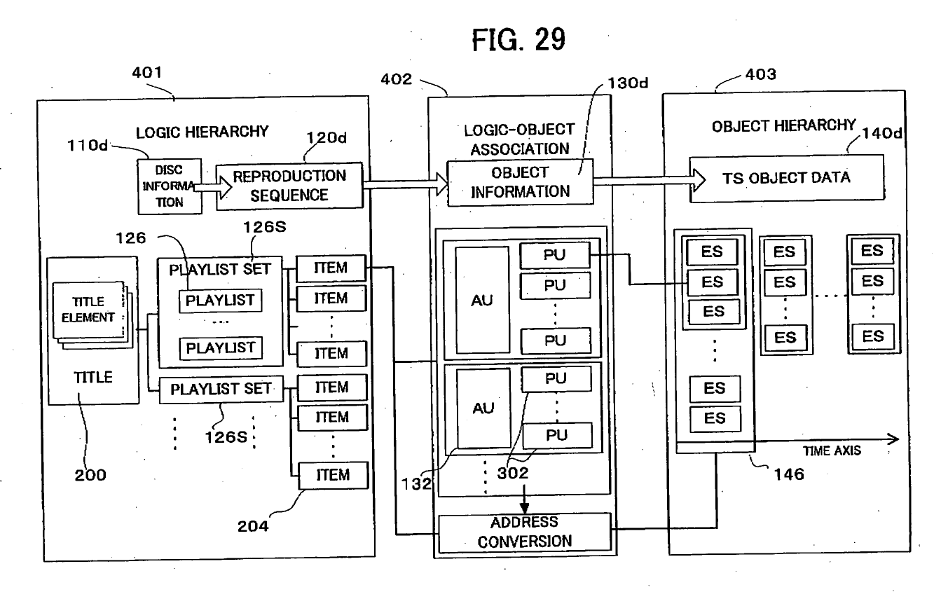

Next, with reference to FIG. 29, the access flow on reproduction by the information record reproduction apparatus 500, employing the AU information 132 and the PU information 302, is explained as one of the features of this embodiment, with the logical structure of the optical disc 100. FIG. 29 schematically illustrates an entire access flow on reproduction, in relation to the logical structure of the optical disc 100.

In FIG. 29, the logical structure of the optical disc 100 is categorized roughly into the following three hierarchies: a logic hierarchy 401; an object hierarchy 403; and a logic-object association hierarchy 402 mutually associating those two hierarchies.

Among them, the logic hierarchy 401 is a hierarchy for logically specifying various logical information to reproduce the desired title during the reproduction, as well as the play list (P list) to be reproduced and its constitutional contents. In the logic hierarchy 401, disc information 110d indicating the entire titles 200 and the like on the optical disc 100 is written within the disc information file 110 (see FIG. 3), and further, reproduction sequence information 120d of the entire contents on the optical disc 100 is written within the play list information file 120 (see FIG. 3). More specifically, the construction of one or more play list sets 126S is written, as the reproduction sequence information 120d, respectively for one or more title elements 200-2 included in each title 200. Furthermore, each play list set 126S includes one or more play lists 126, in each of which the construction of one or more items 204 (see FIG. 13) is written. Then, at the time of the access during the reproduction, the logic hierarchy 401 as described above specifies the title 200 to be reproduced, the play list 126 corresponding to this, and further the item 204 corresponding to this.

Next, the logic-object association hierarchy 402 is a hierarchy for specifying the attribute and the physical storage address of the TS object data 140d to be reproduced, so as to specify the combination and/or the construction of the TS object data 140d as the entity data and perform an address conversion to the object hierarchy 403 from the logic hierarchy 401, on the basis of the information specified in the logic hierarchy 401 as described above. More specifically, in the logic-object association hierarchy 402, the object information data 130d, which separates a group of the contents composing each item 204 into units of the AU 132 and which finely separates each AU 132 into units of the PU 302, is written in the object information file 130 (see FIG. 3).

Here, the “PU (Presentation Unit) 302” is a unit associating and uniting a plurality of elementary streams by the reproduction switchable unit. If there are three audio streams in the PU 302, the user can freely switch these three audio (e.g. audio for each language), during the reproduction of this vision.

On the other hand, the “AU (Associate Unit) 132” is a unit uniting a plurality of elementary streams such as video streams in the TS object used in one title, and made of one or more PUs 302. More specifically, it is a unit uniting the elementary stream packet IDs (ES_PID) for each TS object, indirectly via the PU 302. This AU 132 corresponds to an assembly made of a plurality of programs having a specific inter-relationship in view of the contents, such as a plurality of programs switchable to each other in the multi-source broadcasting. The PUs 302 belonged to the same AU 132 corresponds to one or more elementary stream assemblies each constructing a plurality of programs switchable to each other by the user operation during the reproduction.

Therefore, if the AU 132 to be reproduced is identified, and the PUs belonged to the AU are identified, the elementary stream to be reproduced is identified. That is, a desired elementary stream can be reproduced from the multi-recorded optical disc 100, without using the PAT or the PMT shown in FIG. 12.

Incidentally, a further specific data structure of the AU information 132I and the PU information 302I, each defining the AU 132 and the PU 302, is discussed later in detail.

The elementary stream to be actually reproduced herein is identified or designated by the ES_PID that is a packet ID (see FIG. 12) of the elementary stream, on the basis of the PU information 302. At the same time, the information indicating the start time point and the end time point of the reproduction is converted to the elementary stream address information, and thereby the contents in a specific area (or a specific time range) of a specific elementary stream is reproduced.

Thus, in the logic-object association hierarchy 402, an address conversion is performed from a logical address relating to each item 204 to a physical address relating to each PU 302.

Next, the object hierarchy 403 is a physical hierarchy to reproduce the actual TS object data 140d. In the object hierarchy 403, the TS object data 140d is written within the object data file 140 (see FIG. 3). More specifically, TS packets 146 constructing a plurality of elementary streams (ES) are multiplexed at every time point. The multiplexed packets are disposed on the time axis to form a plurality of elementary streams (see FIG. 11). Then, a plurality of TS packets multiplexed at each time point are associated with a PU 302 identified by the logic-object association hierarchy 402, for each elementary stream. Incidentally, it is possible to associate a plurality of PUs 302 with one elementary stream (e.g. one elementary stream relating to the same audio data is shared, or one elementary stream relating to the same sub-video data is shared, among a plurality of switchable programs).

Thus, in the object hierarchy 403, the object data is actually reproduced, using the physical address obtained from the conversion in the logic-object association hierarchy 402.

As described above, the three hierarchies shown in FIG. 29 allow making an access to the optical disc 100 during the reproduction.

(Structure of Object Information File)

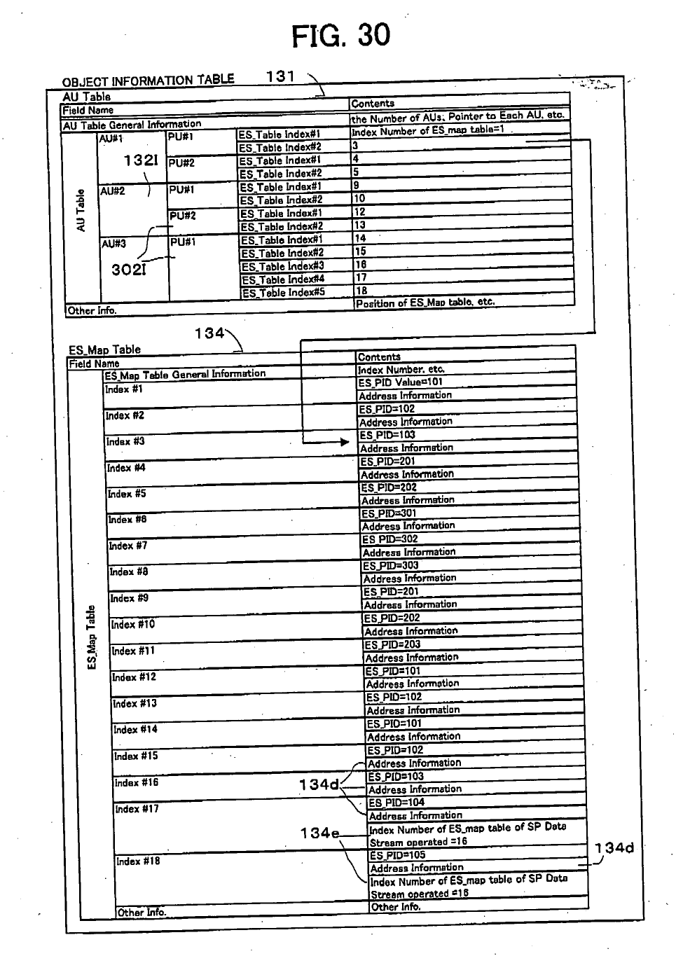

Next, with reference to FIG. 30, an explanation is made on a specific example of a data structure in the object information file 130, which associates the object data in the object data file 140 with various logic informations in the play list information file 120 and the disc information file 110 discussed as for FIG. 29. FIG. 30 schematically shows one specific example of the data structures of the AU (Associate Unit) table 131 (refer to FIG. 3) constructed in the object information file 130 and the ES (Elementary Stream) map table 134 (refer to FIG. 3) related to the AU table 134.

In this specific example, as shown in FIG. 30, the object information table is stored in the object information file 130. The object information table is provided with the AU table 131 shown in the upper part of FIG. 30 and the ES map table 134 shown in the lower part.

In the upper part of FIG. 30, the AU table 131 may have a structure that allows the required number of tables for each Field to be added. For example, if there are four AUs, it may have such a structure that the number of the Fields increases to four.

In the AU table 131, there are stored “AU table general information” in which the number of AUs and the pointer to each AU, and the like are written, and “the other information.”

The AU table 131 describes therein the Index number (Index number=. . .) of the corresponding ES map table 134, as the AU information 132I which indicates an ES table Index #m in each PU #m corresponding to each AU #n. Here, the “AU” is a unit corresponding to a “show” in TV broadcast, for example, as mentioned above (especially, in the case of “multi-vision” broadcasting, it is a unit of a group of a plurality of “visions” which is changeable or selectable), and it includes one or more PUs, each of which is a reproduction unit. Moreover, the “PU” is a group of mutually changeable elementary streams which are included in each AU, as described above, and the ES table Index #m corresponding to each PU is specified by the PU information 302I. For example, if multi-view contents are provided with the AU, the AU stores therein a plurality of PUs, and each PU stores therein the pointers to a plurality of elementary stream packet IDs which indicate the packets constituting the contents of each view. This indicates the Index number in the ES map table 134, as described later.

In the lower part of FIG. 30, in the ES map table 134, there are stored ES map table general information, a plurality of Indexes #m (m=1, 2, . . .), and the “other information”, for each Field.

The “ES map table general information” describes therein the size of the ES map table, the total number of Indexes, and the like.

The “Index #m” includes the elementary stream packet ID (ES_PID) of the entire elementary stream to be used for the reproduction, the corresponding Index number, and the address information of the elementary stream.

In the embodiment, for example, if the elementary stream is the video stream of the MPEG 2 as described above, only the TS packet number of the TS packet at the head of the I picture, and the corresponding display time length are written, as the address information, i.e. the ES address information 134d, on the ES map table 134, by which the data amount is tried to be reduced.

Because of the construction as described above, it is possible to obtain the elementary stream packet ID (ES_PID) of the actual elementary stream, from the Index number of the ES map 134 specified from the AU table 131. Moreover, since the address information of the elementary stream corresponding to the elementary stream packet ID can be obtained at the same time, it is possible to reproduce the object data on the basis of these information.

According to the data structure of the optical disc 100 explained above, even in adding a new title to the optical disc 100, necessary information can be easily added, which is useful. On the other hand, even if some information becomes unnecessary as a result of editing or the like, for example, what is to be done is simply not to refer to the information, and it is not necessary to actually delete the information from the table, which is useful, as well.

As explained in detail with reference to FIG. 1 to FIG. 30, according to this embodiment, using the SP data and the SP control information and the like makes it possible to display one or more buttons highlighted or highlightable in the sub-frame image displayed at a partial area of the main video image, and scroll the sub-frame image in which the button is highlighted. In this case, it can be avoided that the highlighted display area adversely deviates from the button display area with scrolling.

Incidentally, in the aforementioned embodiment, the explanation is made on the optical disc 100 as an example of the information record medium and the recorder or player of the optical disc 100 as an example of the information record reproduction apparatus. Nevertheless, the present invention is not limited to the optical disc and the player or recorder thereof, but is applicable to various record media and the recorders or players thereof, supporting other high density recording or high transfer rate.

The present invention is not limited to the above-described embodiments, and various changes may be made, if desired, without departing from the essence or spirit of the invention which can be read from the claims and the entire specification. An information record medium, an apparatus for and a method of recording the information, an apparatus for and a method of reproducing the information, an apparatus for and a method of recording and reproducing the information, a computer program for controlling the record or the reproduction, and a data structure including a control signal, all of which involves such changes, are also intended to be within the technical scope of the present invention.

### INDUSTRIAL APPLICABILITY

An information record medium, a apparatus for and a method of recording the information, an apparatus for and a method of reproducing the information, an apparatus for and a method of recording and reproducing the information, a computer program for controlling the record or the reproduction, and a data structure including a control signal, all of which are according to the present invention, can be applied to a high-density optical disc for consumer or industrial use, such as a DVD, on which various information, such as the video information, the audio information and the sub-video information, can be recorded at high density and further can be applied to a DVD player, a DVD recorder, and the like. Moreover, they can be applied to an information record medium, an information record reproduction apparatus, or the like, which are mounted on or can be connected to various computer equipment for consumer or industrial use, for example.

1. An information record medium comprising:
video information to indicate a main video;
sub-video information to indicate a sub-video, the sub-video at least partially displayable over the main video;
predetermined part coordinate information to designate coordinates of a predetermined part included in the sub-video, in a coordinate system defined with respect to the sub-video; and
sub-video control information including (i) coordinates-before-movement information to indicate coordinates of a sub-frame before a movement in the coordinate system, the sub-frame being at least an area of the sub-video, and (ii) coordinates-after-movement information to indicate coordinates of the sub frame after n-th movement (n is natural number equal to or more than 1) in the coordinate system.

2. The information record medium according to claim 1, wherein
the predetermined part is a button video part, and
the predetermined part coordinate information is button position information to indicate coordinates of the button video part.

3. The information record medium according to claim 2, wherein
the sub-video control information further includes first button status information to indicate in which status a button, which is indicated by the button video part before the movement of the sub-frame, is among predetermined kinds of preset button status.

4. The information record medium according to claim 3, wherein
the sub-video control information further includes second button status information to indicate in which status a button, which is indicated by the button video part after the n-th movement of the sub-frame, is among the predetermined kinds of preset button status.

5. The information record medium according to claim 2, wherein
the sub-video control information further includes button command information to define a button command to be executed in a case that the button is operated.

6. The information record medium according to claim 2, further comprising:
high light information to define how to control a high light display for the button video part.

7. The information record medium according to claim 6, wherein
the high light information to define how to control the high light display defines which display mode is used to perform the high light display among predetermined kinds of preset display mode, depending on the button status among predetermined kinds of preset button status of a button displayed on the main video.

8. The information record medium according to claim 1, wherein
a sub-video information set comprises the sub-video information and the predetermined part coordinate information, and
the main video information, the sub-video information set and the sub-video control information are divided into predetermined packets and multiplexed, and further streamed into a video stream comprising the divided main video, a sub-video stream comprising the divided sub-video information set and a control information stream comprising the divided sub-video control information.

9. An information record apparatus comprising:
a first record device for recording video information to indicate a main video;
a second record device for recording sub-video information to indicate a sub-video, the sub-video at least partially displayable over the main video, and predetermined part coordinate information to designate coordinates of a predetermined part included in the sub-video, in a coordinate system defined with respect to the sub-video; and
a third record device for recording sub-video control information including (i) coordinates-before-movement information to indicate coordinates of a sub-frame before a movement in the coordinate system, the sub-frame being at least an area of the sub-video, and (ii) coordinates-after-movement information to indicate coordinates of the sub frame after n-th movement (n is natural number equal to or more than 1) in the coordinate system.

10. An information record method comprising:
a first record process of recording video information to indicate a main video;
a second record process of recording sub-video information to indicate a sub-video, the sub-video at least partially displayable over the main video, and predetermined part coordinate information to designate coordinates of a predetermined part included in the sub-video, in a coordinate system defined with respect to the sub-video; and
a third record process of recording sub-video control information including (i) coordinates-before-movement information to indicate coordinates of a sub-frame before a movement in the coordinate system, the sub-frame being at least an area of the sub-video, and (ii) coordinates-after-movement information to indicate coordinates of the sub frame after n-th movement (n is natural number equal to or more than 1) in the coordinate system.

11. An information reproduction apparatus for reproducing the information record medium according to claim 1, said apparatus comprising:
a reproduction device for reproducing the video information, the sub-video information, the predetermined part coordinate information and the sub-video control information;
a display output device capable of displaying the reproduced sub-video information over the reproduced video information;
a control device for controlling the reproduction device and the display output device to display, before the movement of the sub-frame, the predetermined part within the sub-frame before the movement after the predetermined part is subjected to a predetermined kind of processing on the basis of the reproduced predetermined part coordinate information, while displaying the sub-frame before the movement over the main video on the basis of the coordinates-before-movement information included in the reproduced sub video control information, and to display, after the movement of the sub-frame, the predetermined part within the sub-frame after the movement after the predetermined part is subjected to a predetermined kind of processing on the basis of the reproduced predetermined part coordinate information, while displaying the sub-frame after the movement over the main video on the basis of the coordinates-after-movement information included in the reproduced sub-video control information.

12. The information reproduction apparatus according to claim 11, wherein
the predetermined part is a button video part,
the predetermined part coordinate information is button position information to indicate coordinates of the button video part,
the information record medium further comprises high light information to define how to control a high light display for the button video part,
the reproduction device further reproduces the high light information, and
the control device controls the reproduction device and the display output device to perform the high light display as the predetermined kind of processing for the button video part, on the basis of the reproduced high light information.

13. An information reproduction method of reproducing the information record medium according to claim 1, implemented with an information reproduction apparatus comprising (i) a reproduction device for reproducing the video information, the sub-video information, the predetermined part coordinate information and the sub-video control information and (ii) a display output device capable of displaying the reproduced sub-video information over the reproduced video information, said method comprising:
a first control process of controlling the reproduction device and the display output device to display, before the movement of the sub-frame, the predetermined part within the sub-frame before the movement after the predetermined part is subjected to a predetermined kind of processing on the basis of the reproduced predetermined part coordinate information, while displaying the sub-frame before the movement over the main video on the basis of the coordinates-before-movement information included in the reproduced sub video control information; and
a second control process of controlling the reproduction device and the display output device to display, after the movement of the sub-frame, the predetermined part within the sub-frame after the movement after the predetermined part is subjected to a predetermined kind of processing on the basis of the reproduced predetermined part coordinate information, while displaying the sub-frame after the movement over the main video on the basis of the coordinates-after-movement information included in the reproduced sub-video control information.

14. An information record reproduction apparatus comprising:
a first record device for recording video information to indicate a main video;
a second record device for recording sub-video information to indicate a sub-video, the sub-video at least partially displayable over the main video, and predetermined part coordinate information to designate coordinates of a predetermined part included in the sub-video, in a coordinate system defined with respect to the sub-video;
a third record device for recording sub-video control information including (i) coordinates-before-movement information to indicate coordinates of a sub-frame before a movement in the coordinate system, the sub-frame being at least an area of the sub-video, and (ii) coordinates-after-movement information to indicate coordinates of the sub frame after n-th movement (n is natural number equal to or more than 1) in the coordinate system;
a reproduction device for reproducing the video information, the sub-video information, the predetermined part coordinate information and the sub-video control information;
a display output device capable of displaying the reproduced sub-video information over the reproduced video information; and
a control device for controlling the reproduction device and the display output device to display, before the movement of the sub-frame, the predetermined part within the sub-frame before the movement after the predetermined part is subjected to a predetermined kind of processing on the basis of the reproduced predetermined part coordinate information, while displaying the sub-frame before the movement over the main video on the basis of the coordinates-before-movement information included in the reproduced sub video control information, and to display, after the movement of the sub-frame, the predetermined part within the sub-frame after the movement after the predetermined part is subjected to a predetermined kind of processing on the basis of the reproduced predetermined part coordinate information, while displaying the sub-frame after the movement over the main video on the basis of the coordinates-after-movement information included in the reproduced sub-video control information.

15. An information record reproduction method implemented with an information record reproduction apparatus comprising (i) a reproduction device for reproducing the video information, the sub-video information, the predetermined part coordinate information and the sub-video control information and (ii) a display output device capable of displaying the reproduced sub-video information over the reproduced video information, said method comprising:
a first record process of recording video information to indicate a main video;
a second record process of recording sub-video information to indicate a sub-video, the sub-video at least partially displayable over the main video, and predetermined part coordinate information to designate coordinates of a predetermined part included in the sub-video, in a coordinate system defined with respect to the sub-video;
a third record process of recording sub-video control information including (i) coordinates-before-movement information to indicate coordinates of a sub-frame before a movement in the coordinate system, the sub-frame being at least an area of the sub-video, and (ii) coordinates-after-movement information to indicate coordinates of the sub frame after n-th movement (n is natural number equal to or more than 1) in the coordinate system;
a first control process of controlling the reproduction device and the display output device to display, before the movement of the sub-frame, the predetermined part within the sub-frame before the movement after the predetermined part is subjected to a predetermined kind of processing on the basis of the reproduced predetermined part coordinate information, while displaying the sub-frame before the movement over the main video on the basis of the coordinates-before-movement information included in the reproduced sub video control information; and
a second control process of controlling the reproduction device and the display output device to display, after the movement of the sub-frame, the predetermined part within the sub-frame after the movement after the predetermined part is subjected to a predetermined kind of processing on the basis of the reproduced predetermined part coordinate information, while displaying the sub-frame after the movement over the main video on the basis of the coordinates-after-movement information included in the reproduced sub-video control information.

16. A computer program for a record control to control a computer disposed at the information record apparatus according to claim 9, said program making the computer function as at least a part of the first record device, the second record device and the third record device.

17. A computer program for a reproduction control to control a computer disposed at the information reproduction apparatus according to claim 11, said program making the computer function as at least a part of the reproduction device, the display output device and the control device.

18. A computer program for a record reproduction control to control a computer disposed at the information record reproduction apparatus according to claim 14, said program making the computer function as at least a part of the first record device, the second record device, the third record device, the reproduction device, the display output device and the control device.

19. A data structure including a control signal, said structure comprising:
video information to indicate a main video;
sub-video information to indicate a sub-video, the sub-video at least partially displayable over the main video;
predetermined part coordinate information to designate coordinates of a predetermined part included in the sub-video, in a coordinate system defined with respect to the sub-video; and
sub-video control information including (i) coordinates-before-movement information to indicate coordinates of a sub-frame before a movement in the coordinate system, the sub-frame being at least an area of the sub-video, and (ii) coordinates-after-movement information to indicate coordinates of the sub frame after n-th movement (n is natural number equal to or more than 1) in the coordinate system.
